(19) United States
(12) Patent Application Publication
(10) Pub. No.: US 2009/0241107 A1
(43) Pub. Date: Sep. 24, 2009

(54) LICENSE FILE ISSUANCE APPARATUS, IMAGE PROCESSING APPARATUS, LICENSE FILE ISSUANCE METHOD, APPLICATION INSTALLATION METHOD, AND STORAGE MEDIUM

(75) Inventor: Makoto Kobayashi, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/408,480

(22) Filed: Mar. 20, 2009

(30) Foreign Application Priority Data
Mar. 21, 2008 (JP) 2008-074392

(51) Int. Cl. G06F 21/22; G06F 9/445

(52) U.S. Cl. 717/178; 726/28; 717/174

(57) ABSTRACT

An apparatus for issuing license files includes an acceptance unit configured to accept a license file issuance request, and a license file issuance unit configured to issue a license file that includes license information for a first application of an image processing apparatus and customization information relating to customization of the first application, if the acceptance unit accepts the license file issuance request.

### BACKGROUND OF THE INVENTION

1. Field of the Invention

The present invention relates to a license file issuance apparatus, an image processing apparatus, a license file issuance method, and an application installation method.

2. Description of the Related Art

A license management system has a function of managing an application and information relating to a device that executes the application and a function of license management for enabling the application on a device that is permitted to execute the application.

Information managed by a license management system includes an ID of a device that installs and executes an application, an ID of the application itself, and parameters relating to execution of the application (e.g., effective period). The license management system issues a license based on a device ID, an application ID, and license parameters (e.g., effective period). The application and a license are installed together on a device, so that the application is enabled when predetermined conditions (e.g., license parameters) are satisfied.

### SUMMARY OF THE INVENTION

According to an aspect of the present invention, an apparatus for issuing license files includes an acceptance unit configured to accept a license file issuance request, and a license file issuance unit configured to issue a license file that includes license information for a first application of an image processing apparatus and customization information relating to customization of the first application, if the acceptance unit accepts the license file issuance request.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain at least some of the principles of the invention.

FIG. 1 illustrates an example of a system configuration of a network system according to a first exemplary embodiment of the present invention.

FIG. 2 illustrates an example of a hardware configuration of an information processing apparatus, such as a license information issuance server.

FIG. 3 illustrates an example of a screen that enables each actor (a dealing company or a software developer) to log in a license information issuance server with a registered log-in account.

FIG. 4 illustrates an example of a license information management database.

FIG. 5 illustrates an example of an application designation screen provided by the license information issuance server.

FIG. 6 illustrates an example of a product type designation screen provided by the license information issuance server.

FIG. 7 illustrates an example of a product registration screen provided by the license information issuance server.

FIG. 8 illustrates an example of a screen for designating a software identification code issuance product provided by the license information issuance server.

FIG. 9 illustrates an example of a software identification code issuance screen provided by the license information issuance server.

FIG. 10 illustrates an example of a software identification code input screen provided by the license information issuance server.

FIG. 11 illustrates an example of a license information issuance screen provided by the license information issuance server.

FIG. 12 illustrates an example of a license information acquisition screen provided by the license information issuance server.

FIG. 13 illustrates an example of the product registration screen provided by the license information issuance server 101, which may be displayed when a selected product is the type that does not require designation of license conditions in the product registration.

FIG. 14 illustrates an example of a screen for designating a license information issuance object product provided by the license information issuance server, which may be displayed when the dealing company or the software developer issues license information.

FIG. 15 illustrates an example of the license information issuance screen provided by the license information issuance server, which may be displayed when the dealing company or the software developer issues license information.

FIG. 16 illustrates an example of the license information management database.

FIG. 17 is a flowchart illustrating an example of license product registration processing performed by the license information issuance server.

FIG. 18 is a flowchart illustrating an example of device product registration processing performed by the license information issuance server.

FIG. 19 illustrates an example of a device product registration screen.

FIG. 20 illustrates an example of a device product registration confirmation screen.

FIG. 21 illustrates an example of an option registration screen.

FIG. 22 illustrates an example of an optional product registration screen.

FIG. 23 illustrates an example of an optional product registration confirmation screen.

FIG. 24 is a flowchart illustrating an example of optional product registration processing performed by the license information issuance server.

FIG. 25 illustrates an example of information included in the license information management database.

FIG. 26 is a flowchart illustrating an example of software identification code issuance processing.

FIG. 27 is a flowchart illustrating an example of license information issuance processing performed in response to a request from a user.

FIG. 28 is a flowchart illustrating an example of license information issuance processing performed in response to a request from the dealing company or the software developer.

FIG. 29 illustrates an example of an optional product search screen to be used for issuance of a license access number (LA#).

FIG. 30 illustrates an example of an option information display screen to be used for issuance of the LA#.

FIG. 31 illustrates an example of a download screen to be used for issuance of the LA#.

FIG. 32 is a flowchart illustrating an example of control processing performed by an LA# issuance unit.

FIG. 33 is a flowchart illustrating an example of processing performed by a user terminal, when a license key for an optional product is issued.

FIG. 34 illustrates an example of information included in a personal information database.

FIG. 35 illustrates an example of a license access number input screen usable for license key issuance processing.

FIG. 36 illustrates an example of a device serial number input screen usable for license key issuance processing.

FIG. 37 illustrates an example of a personal information input screen usable for personal information input processing of license key issuance processing.

FIG. 38 illustrates an example of an information confirmation screen usable for license key issuance processing.

FIG. 39 illustrates an example of a license key issuance completion screen usable for license key issuance processing.

FIG. 40 is a flowchart illustrating an example of license key issuance processing performed by a personal information server.

FIG. 41 is a flowchart illustrating an example of license key issuance processing performed by a license information issuance server.

FIG. 42 illustrates an example of a system configuration of a network system according to a second exemplary embodiment of the present invention.

FIG. 43 illustrates an example of a functional configuration of a multifunction peripheral (MFP).

FIG. 44 is a flowchart illustrating an example of processing for installing an application and a license file including a resource to be used to customize the application on the MFP.

FIG. 45 is a flowchart illustrating an example of processing performed by the MFP to install the license illustrated in FIG. 44.

FIG. 46 illustrates an example of a license file that includes application customization information.

FIG. 47 illustrates an example of application resource information according to an exemplary embodiment of the present invention.

FIG. 48 is a flowchart illustrating an example of application customization processing performed by the MFP to install a license file including an application and application customization information.

### DETAILED DESCRIPTION OF THE EMBODIMENTS

The following description of exemplary embodiments is illustrative in nature and is in no way intended to limit the invention, its application, or uses. It is noted that throughout the specification, similar reference numerals and letters refer to similar items in the following figures, and thus once an item is described in one figure, it may not be discussed for following figures. Various embodiments, features, and aspects of the invention will be described in detail below with reference to the drawings.

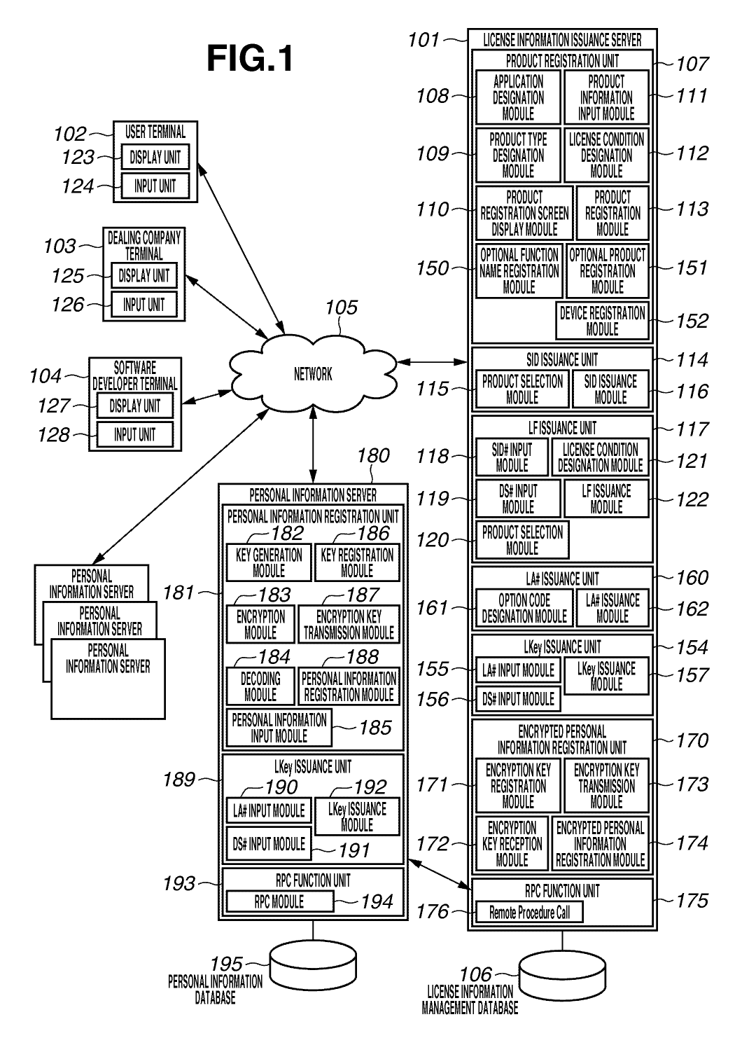

FIG. 1 illustrates an example of a system configuration of a network system according to a first exemplary embodiment of the present invention. The network system issues license information when an individual number that identifies an apparatus that installs software is entered.

A license information issuance server 101 is an information processing apparatus (license file issuance apparatus), which performs license information issuance processing. A user terminal 102 is an information processing apparatus that a user can manage. The user terminal 102 may include a personal computer, a portable terminal, a printer, a copying machine, or an information processing apparatus capable of installing software via a network.

A dealing company terminal 103 is an information processing apparatus that a dealing company can manage. A software developer (manufacturer) terminal 104 is an information processing apparatus that a software developer can manage. Examples of the dealing company terminal 103 and the software developer terminal 104 are personal computers and workstations.

A network 105 may include the Internet. The user terminal 102, the dealing company terminal 103, and the software developer terminal 104 are connected to the license information issuance server 101 via the network 105.

A personal information server 180 is an information processing apparatus that can control the front-end of the license information issuance processing. A plurality of personal information servers, each covering (managing) a designated region, may be present. Each personal information server can communicate with the license information issuance server 101 via the network 105.

A license information management database 106 is stored in a hard disk of the license information issuance server 101. The license information management database 106 stores account information, application information, product information including license information, actor information, software identification code (SID) information, device serial number (DS#) information, device product information, and serial number data band information. The license information management database 106 further stores application ID, device product code association information, optional product information, license access number information, license key information, option information, and customer information. The license information management database 106 may be stored in a hard disk of another server that can communicate with the license information issuance server 101.

The product registration unit 107 is a functional configuration of the license information issuance server 101. The product registration unit 107 includes an application designation module 108, a product type designation module 109, a product registration screen display module 110, a product information input module 111, a license condition designation module 112, and a product registration module 113. The product registration unit 107 further includes an optional function name registration module 150, an optional product registration module 151, and a device registration module 152.

A software identification code (SID) issuance unit 114 is a functional configuration of the license information issuance server 101. The SID issuance unit 114 includes a product selection module 115 and an SID issuance module 116.

A license file (LF) issuance unit 117 is a functional configuration of the license information issuance server 101. The LF issuance unit 117 includes an SID# input module 118, a DS# input module 119, a product selection module 120, a license condition designation module 121, and an LF issuance module 122.

An LA# issuance unit 160 is a functional configuration of the license information issuance server 101. The LA# issuance unit 160 includes an option code designation module 161 that designates an option to issue a license access number (LA#) and a LA# issuance module 162 that issues license access numbers (LA#) referring to the entered number to acquire the LA#.

A license key issuance unit (LKey issuance unit) 154 is a functional configuration of the license information issuance server 101. The LKey issuance unit 154 includes an LA# input module 155, a DS# input module 156, and an LKey issuance module 157.

An encrypted personal information registration unit 170 is a functional configuration of the license information issuance server 101. The encrypted personal information registration unit 170 includes an encryption key registration module 171, an encryption key reception module 172, an encryption key transmission module 173, and an encrypted personal information registration module 174.

A remote procedure call (RPC) function unit 175 is a functional configuration of the license information issuance server 101. The RPC function unit 175 includes an RPC module 176. In the present embodiment, the RPC module 176 executes processing on the license information issuance server 101 in response to a remote function call from the personal information server 180 and returns a return value.

A personal information registration unit 181 is a functional configuration of the personal information server 180. The personal information registration unit 181 includes a key generation module 182, an encryption module 183, a decoding module 184, a personal information input module 185, a key registration module 186, an encryption key transmission module 187, and a personal information registration module 188.

An LKey issuance unit 189 is a functional configuration of the personal information server 180. The LKey issuance unit 189 includes an LA# input module 190, a DS# input module 191, and an LKey issuance module 192.

An RPC function unit 193 is a functional configuration of the personal information server 180. The RPC function unit 193 includes an RPC module 194. The RPC module 194 includes a remote function calling function. In the present embodiment, the RPC module 194 calls a function of the license information issuance server 101 from the personal information server 180.

A personal information database 195 is stored in a hard disk of the personal information server 180. The personal information database 195 includes LA# information, user serial number information, company name information, division name information, zip code information, address information, telephone number information, personnel-in-charge name information, personnel-in-charge telephone number information, and mail address information. The personal information database 195 may be stored in a hard disk of another server that can communicate with the personal information server 180.

A display unit 123 is a functional configuration of the user terminal 102. An input unit 124 is a functional configuration of the user terminal 102. A display unit 125 is a functional configuration of the dealing company terminal 103. An input unit 126 is a functional configuration of the dealing company terminal 103. A display unit 127 is a functional configuration of the software developer terminal 104. An input unit 128 is a functional configuration of the software developer terminal 104.

License information issued by the license information issuance server 101 is always required to install software managed by the system on an information processing apparatus managed by a user. The license information issuance server 101 issues license information in response to an appropriate access received via the network 105 (if a license information issuance request is accepted).

Identification information of an information processing apparatus (an installation destination of the software) can be embedded in the license information. If the same software is installed on another apparatus, different license information is necessary. This may prevent the software from being copied in an unauthorized manner. The license information issued by the license information issuance server 101 includes a license file (LF) and a license key (Lkey).

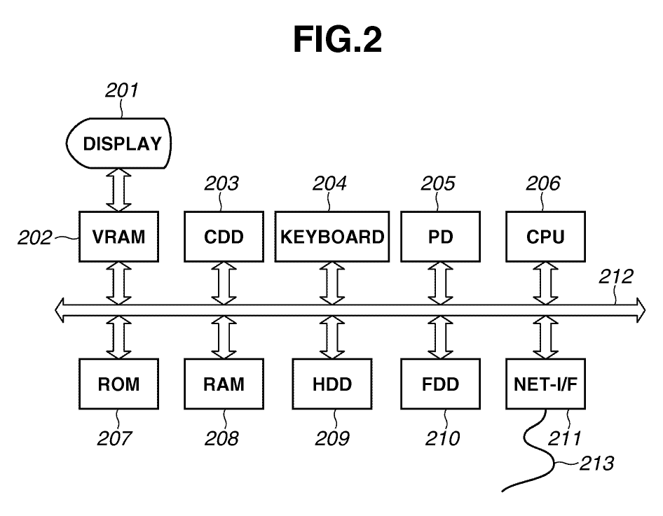

FIG. 2 illustrates an example of a hardware configuration of an information processing apparatus, such as the license information issuance server 101. A display apparatus 201 displays windows, icons, messages, menus, and other user interface information. A video random access memory (VRAM) 202 stores images to be displayed on the display apparatus 201.

The image data stored in the VRAM 202 is transferred to the display apparatus 201 according to a predetermined convention, and the display apparatus 201 displays an image based on the received image data. A compact disk drive (CDD) 203 is an apparatus that can perform reading/writing of various control programs and data from/to a compact-disc read only memory (CD-ROM), a CD-recordable (CD-R), and other recording media. The CDD 203 may be replaced with a DVD drive.

A keyboard 204 includes various keys that enable users to input characters. A pointing device (PD) 205 enables users to instruct icons, menus, and other objects displayed on display screens of the display apparatus 201. A central processing unit (CPU) 206 controls various devices based on control programs stored in a read only memory (ROM) 207 or a hard disk drive (HDD) 209 or programs supplied from a floppy disk drive (FDD) 210, the CDD 203, or an external storage apparatus. The CPU of the license information issuance server 101 executes processing based on the programs to realize functions performed by the above-described license information issuance server 101.

The ROM 207 stores various control programs and data. A random access memory (RAM) 208 includes a work area for the CPU 206, a data retreating area to be used for error processing, and a control program loading area.

The HDD 209 stores various control programs and data. A network interface (Net-I/F) 211 can communicate with another information processing apparatuses and printers via a network 213. A CPU bus 212 includes an address bus, a data bus, and a control bus. The control programs for the CPU 206 can be supplied from the ROM 207, the HDD 209, the FDD 210, and the CDD 203, or can be supplied from another information processing apparatus via the network 213.

The user terminal 102, the dealing company terminal 103, and the software developer terminal 104 may have a hardware configuration similar to that of the license information issuance server 101 illustrated in FIG. 2. When the user terminal 102 is a multifunction peripheral (MFP), the MFP includes a CPU, a ROM and/or a HDD, and a network interface similar to those illustrated in FIG. 2. A CPU of the MFP executes programs stored in the ROM or the HDD to realize various functions of the MFP.

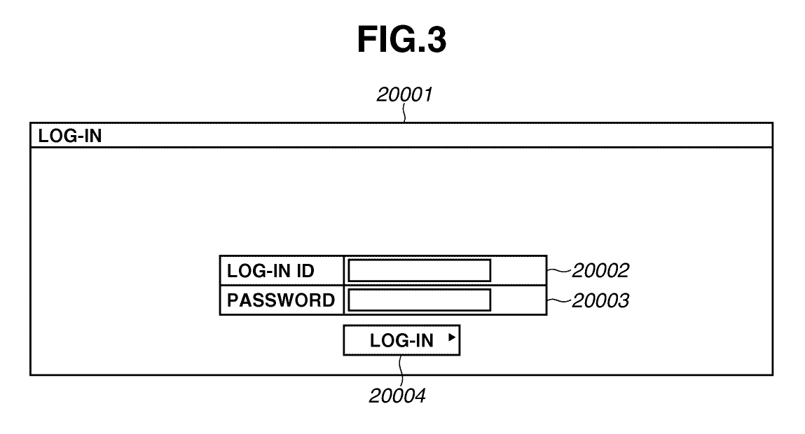

An example operation of the license information issuance server 101 is described below. FIG. 3 illustrates an example of a screen that enables each actor (a dealing company or a software developer) to log into the license information issuance server 101 with a registered log-in account. In FIG. 3, a log-in ID input field 20002, a password input field 20003, and a log-in button 20004 are displayed on a log-in screen 20001. Operators of the dealing company and the software developer, before starting a license information issuance work using the license information issuance server 101, enable the system to display the screen illustrated in FIG. 3 to log into the system.

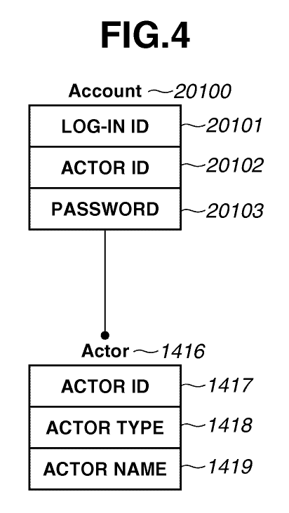

FIG. 4 illustrates an example of the license information management database 106. The license information management database 106 includes account information and actor information.

In FIG. 4, an account table 20100 includes a log-in ID 20101 that identifies an operator who logs into the system, an actor ID 20102 that identifies a selling entity, and a password 20103 to be used for log-in processing.

An actor table 1416 includes information to be used to identify the selling entity, such as an actor ID 1417, an actor type 1418 that indicates the type of the dealing company or the software developer, and an actor name 1419.

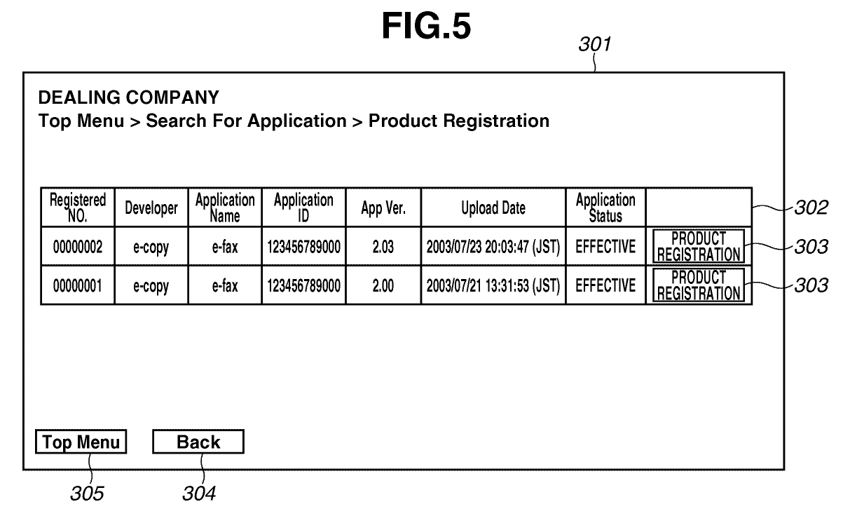

FIG. 5 illustrates an example of an application designation screen provided by the license information issuance server 101. The license information issuance server 101, in response to access from the dealing company terminal 103 via the network 105, transmits image data to be used to display the screen illustrated in FIG. 5 to the dealing company terminal 103.

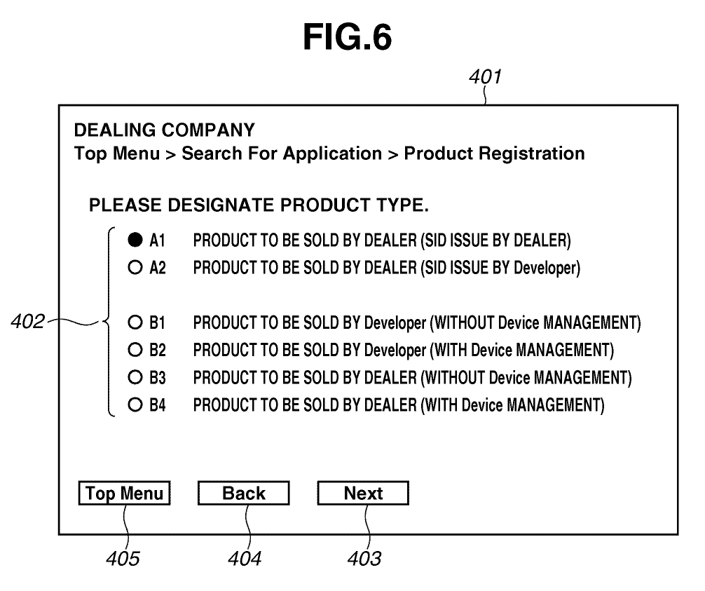

In FIG. 5, an application list 302 and “product registration” buttons 303 are displayed on a product registration application designation screen 301. A dealing company's operator causes the system to display the screen illustrated in FIG. 5 and designates an application (a target to be subjected to the product registration) from the list of applications registered in the system. If the “Product Registration” button 303 is selected, a screen illustrated in FIG. 6 is displayed. If a “Back” button 304 is selected, a previous screen is displayed. If a “Top Menu” button 305 is selected, a Top Menu screen is displayed.

FIG. 6 illustrates an example of a product type designation screen provided by the license information issuance server 101. The license information issuance server 101, in response to an access from the dealing company terminal 103 via the network 105, transmits image data to be used to display the screen illustrated in FIG. 6 to the dealing company terminal 103.

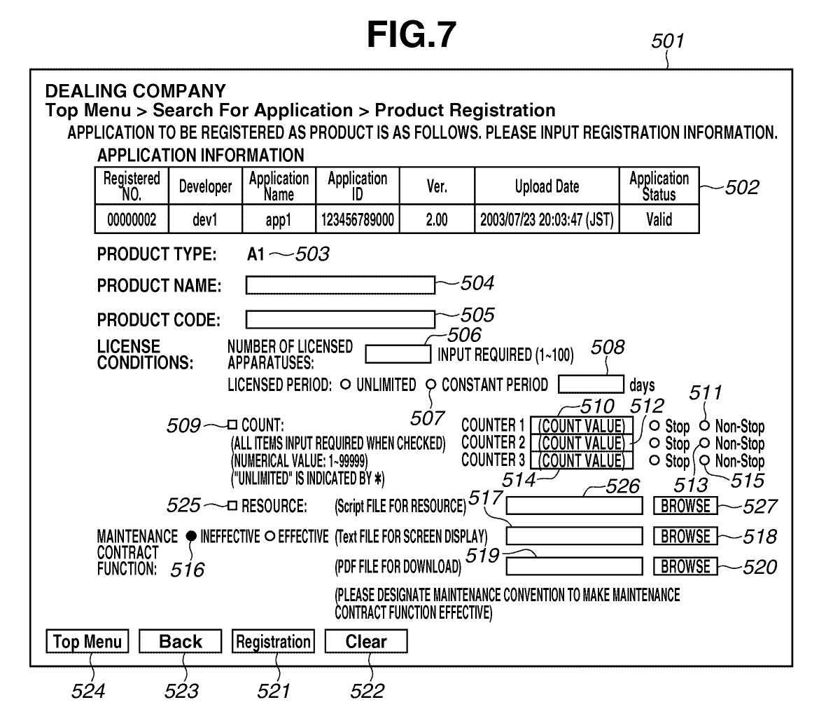

In FIG. 6, selection radio buttons 402 that enable users to select a desirable product type are displayed on a product type designation screen 401. If a product type is selected on the screen illustrated in FIG. 6 and a “NEXT” button 403 is selected, a screen illustrated in FIG. 7 is displayed.

If a “Back” button 404 is selected, the previous screen is displayed. If a “Top Menu” button 405 is selected, the Top Menu screen is displayed.

A product type A1 is a product to be sold by the dealing company serving as a selling entity and a product for which license conditions and the presence of a maintenance contract function are registered. The dealing company acquires a software identification code from the license information issuance server 101 and sells a software package including the acquired software identification code. A user who purchased the product inputs, to the license information issuance server 101, a software identification code and a device serial number of a computer (an object to which the software is installed) and acquires license information. The acquired license information is installed on an information processing apparatus.

A product type A2 is a product to be sold by the dealing company serving as a selling entity and a product for which license conditions and the presence of the maintenance contract function are registered. The software developer acquires a software identification code from the license information issuance server 101 and adds the acquired software identification code to a software package. The dealing company sells the software package. A user who purchased the product inputs, to the license information issuance server 101, a software identification code and a device serial number of an information processing apparatus (an object to which the software is installed) and acquires license information. The license information is installed on the information processing apparatus.

A product type B1 is a product to be sold by the software developer serving as a selling entity and a product whose license conditions are not registered. When the software developer acquires license information from the license information issuance server 101, the software developer acquires the license information by designating license conditions and sells a software package including the acquired license information.

A product type B2 is a product to be sold by the software developer serving as a selling entity and a product whose license conditions are not registered. When the software developer acquires license information from the license information issuance server 101, the software developer acquires the license information by designating license conditions and a device serial number of an information processing apparatus (an object to which the software is installed) and sells a software package including the acquired license information.

A product type B3 is a product to be sold by the dealing company serving as a selling entity and a product whose license conditions are not registered. When the dealing company acquires license information from the license information issuance server 101, the dealing company acquires the license information by designating license conditions and sells a software package including the acquired license information.

A product type B4 is a product to be sold by the dealing company serving as a selling entity and a product whose license conditions are not registered. When the dealing company acquires license information from the license information issuance server 101, the dealing company acquires the license information by designating license conditions and a device serial number of an information processing apparatus (an object to which the software is installed) and sells a software package including the acquired license information.

FIG. 7 illustrates an example of a product registration screen provided by the license information issuance server 101. The license information issuance server 101, in response to an access from the dealing company terminal 103 via the network 105, transmits image data to be used to display the screen illustrated in FIG. 7 to the dealing company terminal 103. More specifically, if the license information issuance server 101 detects that the product type A1 or A2 is selected and the “Next” button 403 is selected on the screen illustrated in FIG. 6, the license information issuance server 101 transmits the screen information of FIG. 7 to the terminal that displays the screen illustrated in FIG. 6.

In FIG. 7, application (product registration object) information 502, a selected product type 503, a product name input box 504, a product code input box 505, and a number of licensed apparatuses input box 506 are displayed on a product registration screen 501. Additionally, a licensed period type designation radio button 507, a licensed period input box 508 to be used when the licensed period is a constant period, a count condition designation check box 509, and a count value input box 510 of counter 1 are displayed on the screen 501. A Stop/Non-Stop designation button 511 of counter 1, a count value input box 512 of counter 2, a Stop/Non-Stop designation button 513 of counter 2, and a count value input box 514 of counter 3 are displayed on the screen 501.

A Stop/Non-Stop designation button 515 of counter 3, an application resource designation check box 525, and an application resource script file name input box 526 are displayed on the screen 501. A file name designation button 527 to be selected for the application resource script file, an effective/ineffective designation radio button 516 for the maintenance contract function, and a file name input box 517 to be used to display a maintenance contract clause screen are displayed on the screen 501. A file name designation button 518 to be selected to display the maintenance contract clause screen, a file name input box 519 to be used to download a maintenance contract clause, and a file name designation button 520 to be selected to download the maintenance contract clause are displayed on the screen 501. A “Registration” button 521, a “Clear” button 522, a “Back” button 523, and a “TopMenu” button 524 are displayed on the screen 501.

If a dealing company's operator confirms the contents of the application (product registration object) on the screen illustrated in FIG. 7, the dealing company's operator inputs a product name, a product code, the number of licensed apparatuses, a licensed period, license count information, and maintenance contract information and then selects the “Registration” button. In this manner, the dealing company's operator can perform product registration. If the dealing company's operator selects the “Clear” button 522, the contents entered on the displayed screen are all cleared. If the dealing company's operator selects the “Back” button 523, the previous screen is displayed. If the “Top Menu” button 524 is selected, the Top Menu screen is displayed.

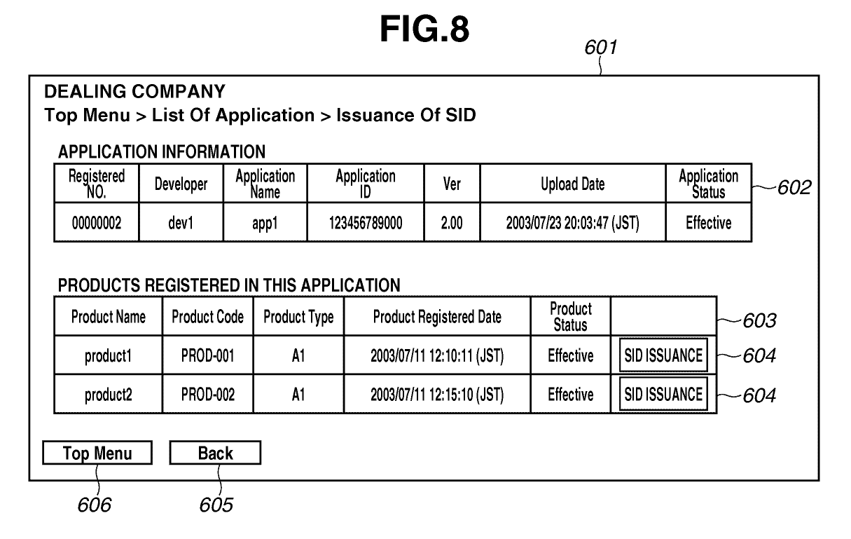

FIG. 8 illustrates an example of a screen for designating a software identification code issuance product provided by the license information issuance server 101. The license information issuance server 101, in response to an access from the dealing company terminal 103 or the software developer terminal 104 via the network 105, transmits image data to be used to display the screen illustrated in FIG. 8 to the dealing company terminal 103 or the software developer terminal 104.

In FIG. 8, application information 602, a product list registered in the application 603, a “SID issuance” button 604, a “Back” button 605, a “Top Menu” button 606 are displayed on a screen 601 for designating a software identification code issuance product.

A dealing company's operator or a software developer's operator, to issue a software identification code, causes the system to display the screen illustrated in FIG. 8. Then, the operator designates a product for which the software identification code is to be issued referring to a product list registered in the object application, among applications registered in the system. If the “Back” button 605 is selected, the previous screen is displayed. If the “Top Menu” button 606 is selected, the Top Menu screen is displayed.

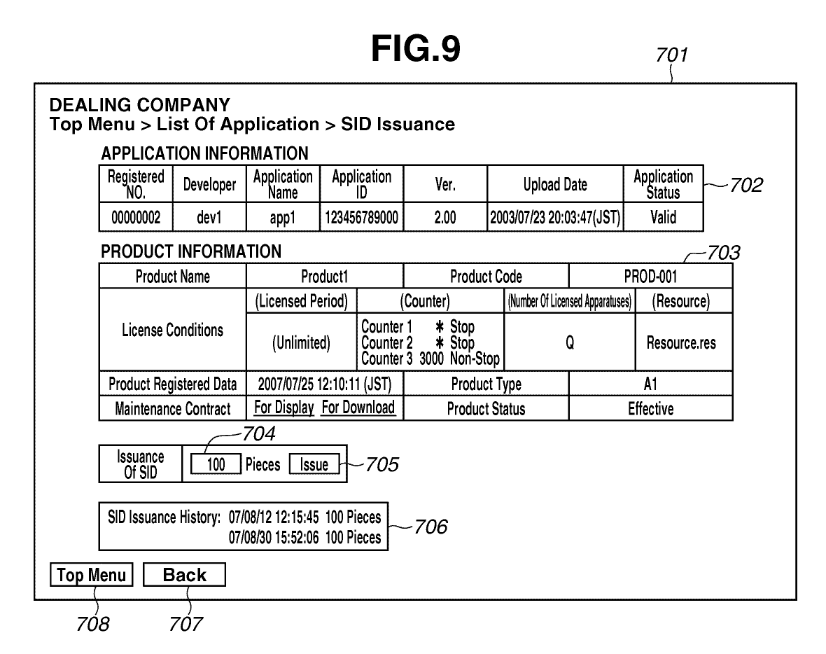

FIG. 9 illustrates an example of a software identification code issuance screen provided by the license information issuance server 101. The license information issuance server 101 detects that the “SID issuance” button 604 is selected in a state where the screen illustrated in FIG. 8 is displayed on the dealing company terminal 103 or the software developer terminal 104. Then, the license information issuance server 101 transmits image data to be used to display the screen illustrated in FIG. 9 to the terminal that displays the screen illustrated in FIG. 8.

In FIG. 9, application information 702, product information 703 (which is registered in the application) of a software identification code issuance object designated on the previous screen, and an input box 704 to be used to input the number of licenses for which the software identification code is to be issued are displayed on a software identification code issuance screen 701. Additionally, an “Issuance” button 705, a software identification code issuance history display 706, a “Back” button 707, a “Top Menu” button 708 are displayed on the software identification code issuance screen 701.

The dealing company's operator or the software developer's operator inputs the number of licenses for which the software identification code is to be issued in the input box 704 and selects the “Issuance” button 705 to instruct issuance of the software identification code.

If the “Back” button 707 is selected, the previous screen is displayed. If the “Top Menu” button 708 is selected, the Top Menu screen is displayed.

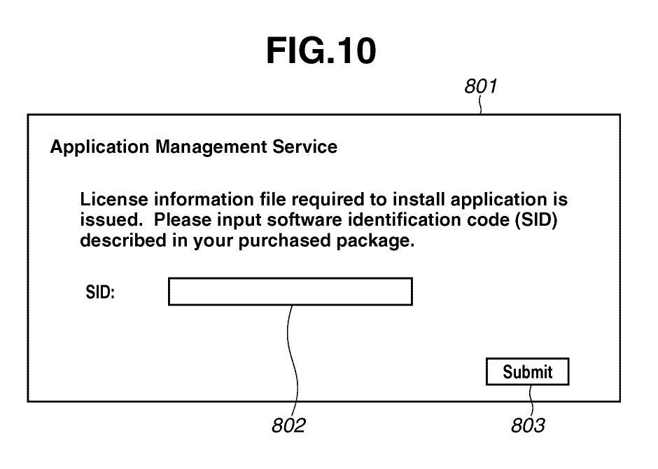

FIG. 10 illustrates an example of a software identification code input screen provided by the license information issuance server 101. The license information issuance server 101, in response to an access from the user terminal 102 via the network 105, transmits image data to be used to display the screen illustrated in FIG. 10 to the user terminal 102.

In FIG. 10, a software identification code input box 802 and a “Submit” button 803 are displayed on a software identification code input screen 801.

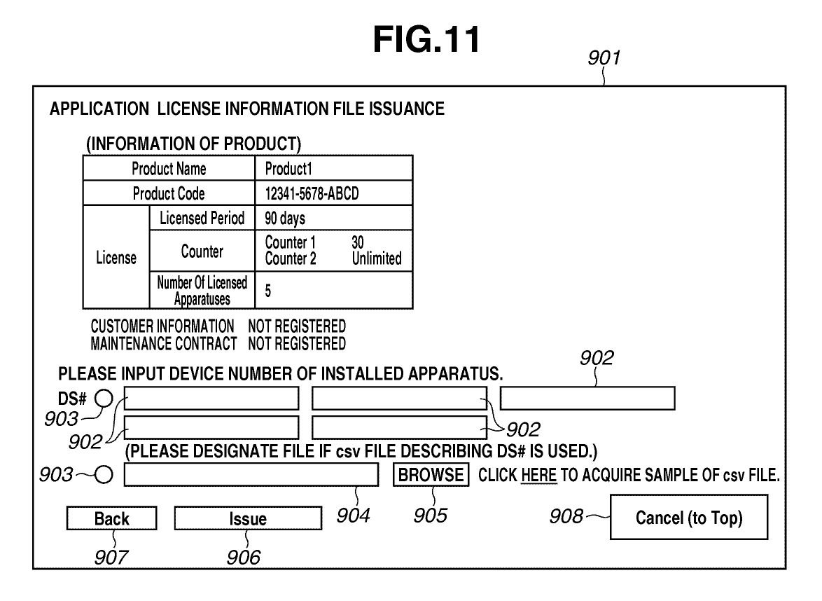

A user who performs issuance of license information, enables the system to display the screen illustrated in FIG. 10. The user inputs a software identification code described in a purchased software package in the input box 802 and selects the “Submit” button 803. When the “Submit” button 803 is selected, a screen illustrated in FIG. 11 is displayed.

FIG. 11 illustrates an example of a license information issuance screen provided by the license information issuance server 101. The license information issuance server 101, in response to a selection of the “Submit” button 803 illustrated in FIG. 10 on the user terminal 102, transmits image data to be used to display the screen illustrated in FIG. 11 to the user terminal 102.

In FIG. 11, software information (which is described as “information of product” in FIG. 11), device serial number input boxes 902, device serial number input method selection radio buttons 903, and a device serial number file name input box 904 are displayed on a license information issuance screen 901 (which is described as “license information file issuance” in FIG. 11). Additionally, a “Browse” button 905 to be selected to designate a device serial number file, an “Issue” button 906 to be selected to instruct an issuance of license information, and a “Back” button 907 to be selected to return the previous screen are displayed on the license information issuance screen 901. A “Cancel” button 908 to be selected to cancel the license information issuance processing is also displayed on the license information issuance screen 901.

The number of the device serial number input boxes 902 corresponds to a value obtained by subtracting the number of issuance completed licenses from the total number of software licenses, if the number of boxes to be displayed does not exceed the maximum number of displayable device serial number input boxes.

After the user confirms that the software information displayed on the screen is the one for the purchased software, the user designates a desired device serial number designation method by selecting one of two buttons 903. If the user selects the upper radio button 903, the user inputs a device serial number of the information processing apparatus that installs the software in the device serial number input box.

If the user selects the lower radio button 903, the user directly inputs an absolute path of a device serial number file in the device serial number file name input box or selects the “Browse” button 905 to be selected to designate a device serial number file. Then, the user designates the device serial number file in a file designation dialog box standardized for the operating system.

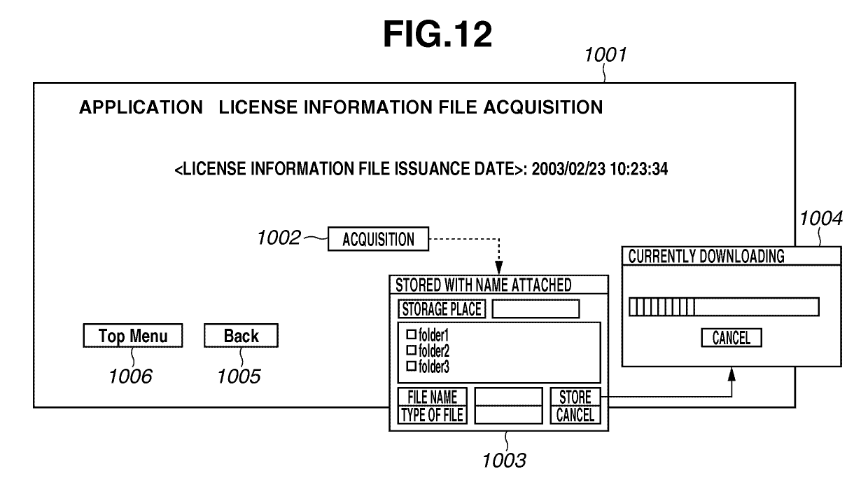

After the user completes the designation of the device serial number using one of the above-described methods, the user selects the “Issue” button 906. In this manner, the license information relating to the input device serial number, which is required when the software is installed, is generated at a predetermined place in the license information issuance server 101. If the generation of the license information is completed, the license information issuance server 101 transmits image data to be used to display the screen illustrated in FIG. 12 to the user terminal 102.

FIG. 12 illustrates an example of a license information acquisition screen provided by the license information issuance server 101. In FIG. 12, license information issuance date and time (which is described as “license information file issuance date” in FIG. 12) and an “Acquisition” button 1002 to be selected to instruct acquisition of license information are displayed on a license information acquisition screen 1001 (which is described as “license information file acquisition” in FIG. 12). Additionally, a “Back” button 1005 to be selected to return to the previous screen and a “Top Menu” button 1006 to be selected to return to the Top menu are displayed on the license information acquisition screen 1001.

If the user selects the “Acquisition” button 1002 on the screen to acquire the previously issued license information (file), a file designation dialog box 1003 standardized for the operating system is displayed. If the user inputs an arbitrary storage destination for the license information (file) and a file name and instructs “Store,” a “Currently Downloading” dialog 1004 standardized for the operating system is displayed and the download is executed.

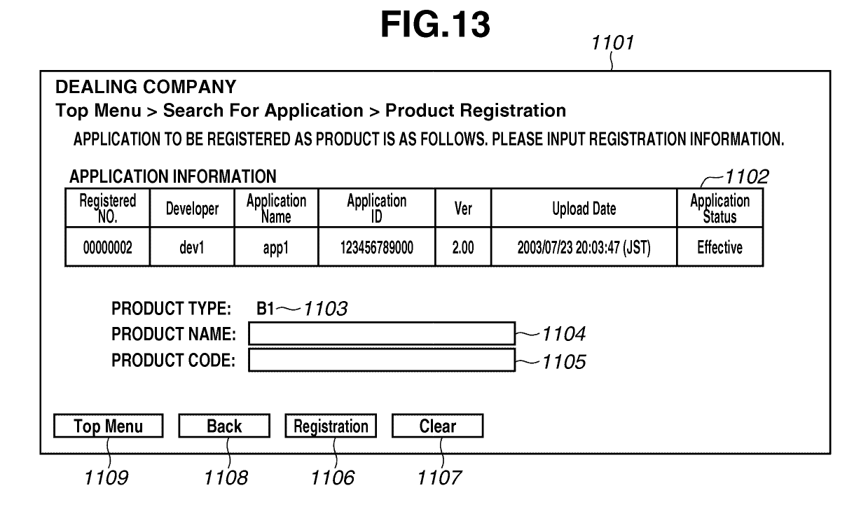

FIG. 13 illustrates an example of a product registration screen provided by the license information issuance server 101, which may be displayed when a selected product is the type that does not require designation of license conditions in the product registration. The license information issuance server 101, in response to an access from the dealing company terminal 103 via the network 105, transmits image data to be used to display the screen illustrated in FIG. 13 to the dealing company terminal 103. More specifically, if the license information issuance server 101 detects that any one of the product types B1 to B4 illustrated in FIG. 6 is selected and the “Next” button 403 is selected, the license information issuance server 101 transmits the screen information illustrated in FIG. 13 to the terminal that displays the screen illustrated in FIG. 6.

In FIG. 13, application (product registration object) information 1102, a selected product type 1103, a product name input box 1104, a product code input box 1105, a “Registration” button 1106, and a “Clear” button 1107 are displayed on a product registration screen 1101. Additionally, a “Back” button 1108 and a “Top Menu” button 1109 are displayed on the product registration screen 1101.

After the dealing company's operator confirms the contents of the application (product registration object) on the screen, the operator inputs a product name and a product code and selects the “Registration” button 1106 to perform the product registration. If the clear button 1107 is selected, the contents entered on the displayed screen are all cleared. If the “Back” button 1108 is selected, the previous screen is displayed. If the “Top Menu” button 1109 is selected, the Top Menu screen is displayed.

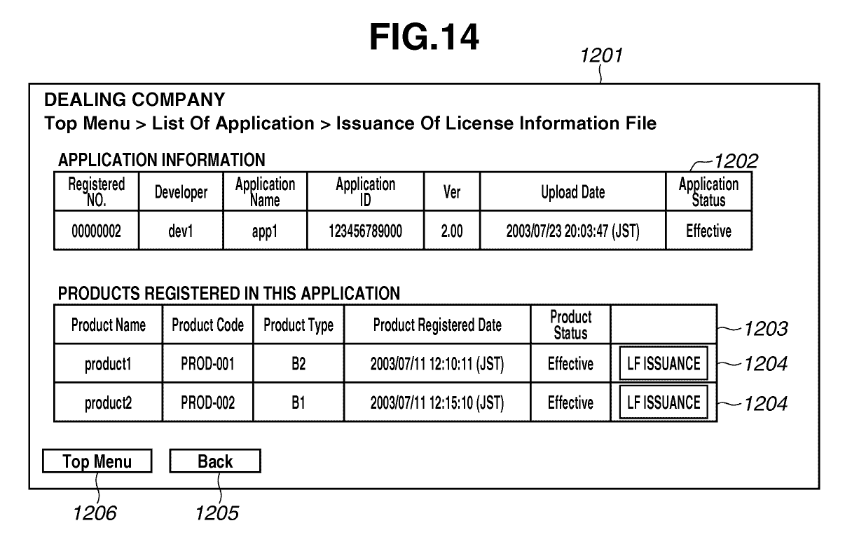

FIG. 14 illustrates an example of a screen for designating a license information issuance object product provided by the license information issuance server 101, which may be displayed when the dealing company or the software developer issues license information.

In FIG. 14, application information 1202, a product list registered in the application 1203, an “LF Issuance” buttons 1204, a “Back” button 1205, and a “Top Menu” button 1206 are displayed on a license information issuance product designation screen 1201.

The dealing company's operator or the software developer's operator, to issue license information, enables the system to display the screen illustrated in FIG. 14. Then the operator designates a product for which the license information is to be issued referring to the product list registered in the object application, among applications registered in the system.

If the “Back” button 1205 is selected, the previous screen is displayed. If the “TopMenu” button 1206 is selected, the “Top Menu screen” is displayed.

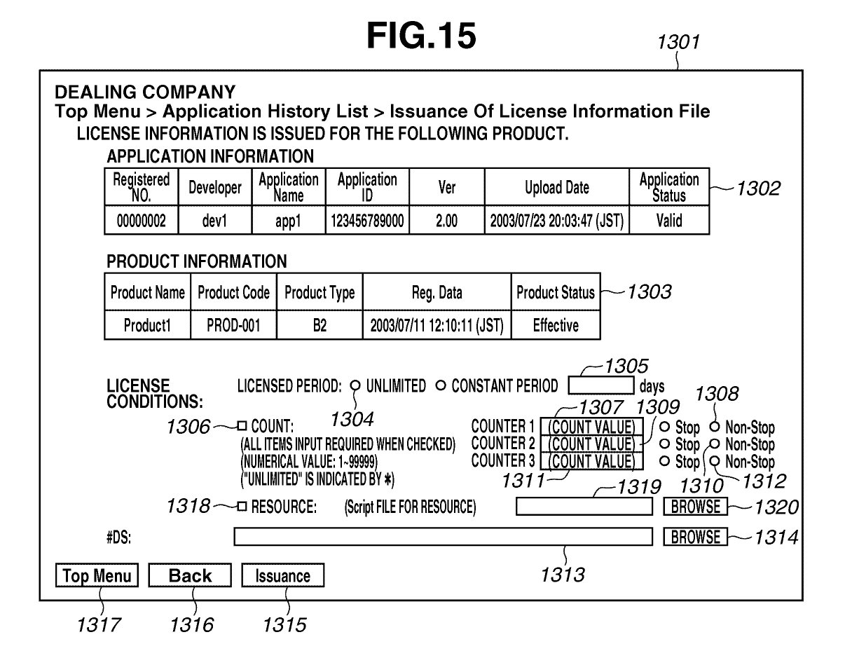

FIG. 15 illustrates an example of a license information issuance screen provided by the license information issuance server 101, which may be displayed when the dealing company or the software developer issues license information. In FIG. 15, application (license information issuance object) information 1302, selected product information 1303, licensed period type designation radio buttons 1304, and a licensed period input box 1305 to be used when the licensed period is a constant period are displayed on a license information issuance screen 1301. Additionally, a count condition designation check box 1306, a count value input box 1307 of counter 1, a Stop/Non-Stop designation button 1308 of counter 1, and a count value input box 1309 of counter 2 are displayed on the license information issuance screen 1301.

A Stop/Non-Stop designation button 1310 of counter 2, a count value input box 1311 of counter 3, and a Stop/Non-Stop designation button 1312 of counter 3 are displayed on the license information issuance screen 1301. An application resource designation check box 1318, a name input box 1319 to be used to input a name of an application resource script file, and a file name designation button 1320 to be selected to designate the application resource script file are displayed on the license information issuance screen 1301. A device serial number input box 1313, a device serial number file designation button 1314, an “Issuance” button 1315, a “Back” button 1316, and a “Top Menu” button 1317 are displayed on the license information issuance screen 1301.

After the operator confirms the contents of the application (license information issuance object) displayed on the screen illustrated in FIG. 15, the operator inputs a licensed period, license count information, and a device serial number of the information processing apparatus that installs the software and then selects the “Issuance” button 1315. In this manner, the operator can request an issuance of the license information. If the “Back” button 1316 is selected, the previous screen is displayed. If the “Top Menu” button 1317 is selected, the Top Menu screen is displayed. If the issuance of the license information is completed, the screen illustrated in FIG. 12 is displayed to enable the operator to acquire the license information.

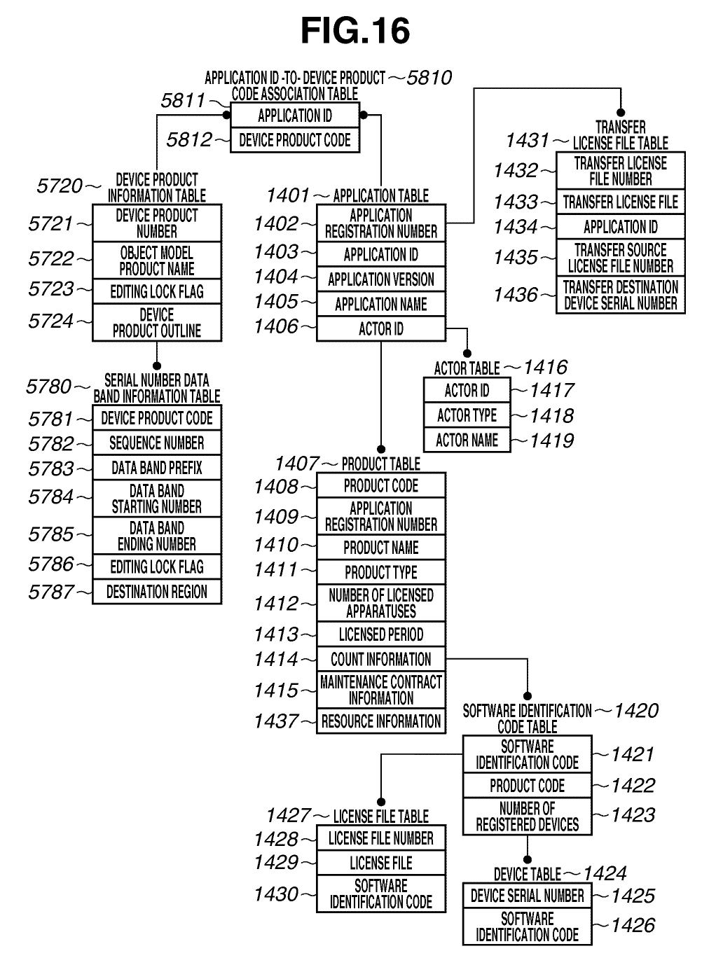

FIG. 16 illustrates an example of the license information management database 106. The license information management database 106 includes application information, product information including license information, actor information, software identification code information, and device serial number information.

In the present embodiment, the “software” is not different from general software that can be installed on an information processing apparatus and operate to produce an intended value. The “application” is software developed by the software developer to cause the information processing apparatus to perform specific processing. The “product” is a sales unit for the application registered in the system, which is defined by a selling entity, a channel of distribution, and license conditions. After each user purchases a product, the user installs the product on a user's own information processing apparatus and uses the product.

An application table 1401 includes information to be used to identify an application operable on the system, such as an application registration number 1402, an application ID 1403, and an application version 1404. The application table 1401 further includes an application name 1405 and an actor ID 1406.

A product table 1407 includes a product code 1408, an application registration number 1409, a product name 1410, a product type 1411, a number of licensed apparatuses 1412, a licensed period 1413, a count information 1414, and maintenance contract information 1415. When the operator performs the product registration via the screens illustrated in FIGS. 5 to 7, the input information is stored in respective fields of the table. As the application and the product are in a one-to-multiple relationship, a plurality of products corresponding to the same application can be present.

An actor table 1416 includes information to be used to identify a selling entity, such as the actor ID 1417, the actor type 1418 that indicates the type of the dealing company or the software developer, and the actor name 1419.

A software identification code table 1420 includes a software identification code 1421, a product code 1422, and a number of registered devices 1423. As the product and the software identification code are in a one-to-multiple relationship, a plurality of software identification code corresponding to the same product can be present.

A device table 1424 includes a device serial number 1425 and a software identification code 1426. As the software identification code and the device are in a one-to-multiple relationship, a plurality of devices corresponding to the same software identification code can be present.

A license file table 1427 includes a license file number 1428, a license file 1429, and a software identification code 1430. The software identification code and the license file are in a one-to-one relationship. As the license file and the license file number are in a one-to-multiple relationship, a plurality of license file numbers corresponding to the same license file can be present.

A transfer license file table 1431 includes a transfer license file number 1432, a transfer license file 1433, an application ID 1434, a transfer source license file number 1435, and a transfer destination device serial number 1436. As the application ID and the transfer license file number are in a one-to-multiple relationship, a plurality of transfer license file numbers corresponding to the same application ID can be present.

A device product information table 5720 includes a device product number 5721 identifying a product, an object model product name 5722, and an editing lock flag 5723 indicating that any change in the contents is inhibited according to an issuance state of LA#.

A serial number data band information table 5780 and the device product information table 5720 are in a one-to-multiple relationship. Therefore, a plurality of serial number data bands corresponding to the same device product can be present. The serial number data band information table 5780 includes a device product code 5781, a sequence number 5782, a data band prefix 5783, a data band starting number 5784, a data band ending number 5785, an editing lock flag 5786, and a destination region 5787.

An application ID-to-device product code association table 5810, which can associate the application with the device product, includes an application ID 5811 and a device product code 5812. As the application ID and the device product are in a one-to-multiple relationship, a plurality of devices products corresponding to the same application ID can be present.

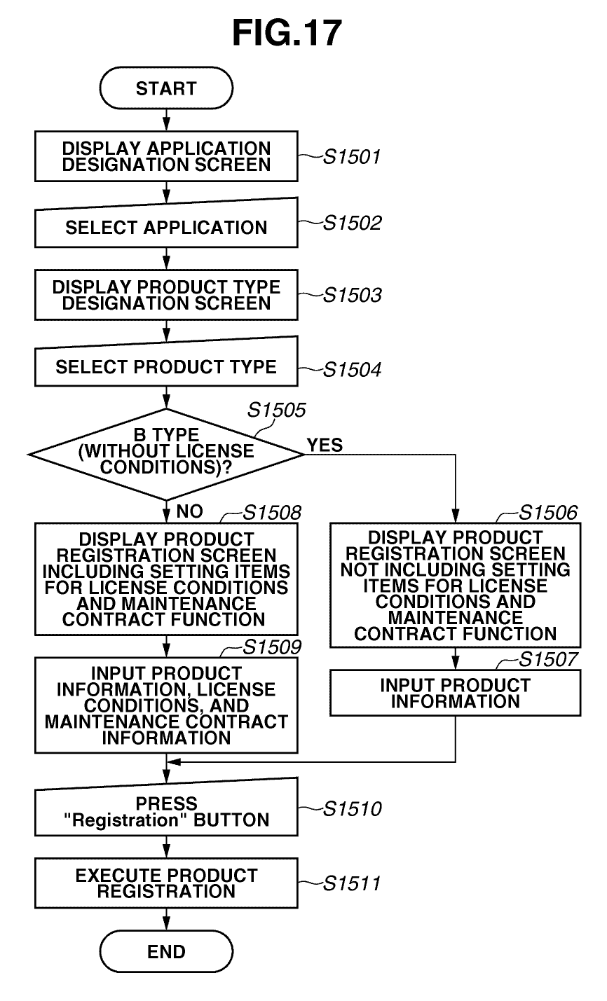

FIG. 17 is a flowchart illustrating an example of license product registration processing performed by the license information issuance server 101. The processing of the flowchart illustrated in FIG. 17 is executed in response to a predetermined start operation for the product registration processing. In step S1501, the license information issuance server 101 displays the application designation screen (FIG. 5) on the display apparatus of the dealing company terminal. In step S1502, the license information issuance server 101 accepts a selection of the “Product Registration” button of an application by a dealing company's operator to perform product registration. If the “Product Registration” button is selected, then in step S1503, the license information issuance server 101 performs display processing for the product type designation screen (FIG. 6).

In step S1504, the operator selects a product type and selects the “Next” button. Then, the processing proceeds to step S1505, in which the license information issuance server 101 determines whether the selected product type is the B type (i.e., the product type that does not require designation of license conditions). If the selected product type is the B type, then in step S1506, the license information issuance server 101 displays the product registration screen (FIG. 13), which does not include setting items for the license conditions and the maintenance contract function.

In step S1507, the license information issuance server 101 accepts an input of product information entered by the operator. Then, the processing proceeds to step S1510. If in step S1505 the selected product type is the B type, then in step S1508, the license information issuance server 101 displays the product registration screen (FIG. 7), which includes setting items for the license conditions and the maintenance contract function.

In step S1509, the license information issuance server 101 accepts product information, license conditions and maintenance contract information entered by the operator. Then, the processing proceeds to step S1510. In step S1510, the operator selects the “Registration” button. Then, in step S1511, the license information issuance server 101 performs registration of the product and terminates the processing of the routine illustrated in FIG. 17.

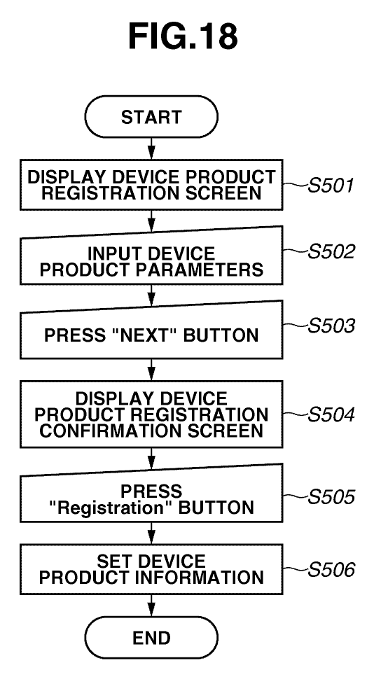

FIG. 18 is a flowchart illustrating an example of device product registration processing performed by the license information issuance server 101. The processing of the flowchart illustrated in FIG. 18 is executed in response to a predetermined start operation for the device product registration processing. In step S501, the license information issuance server 101 displays the device product registration screen.

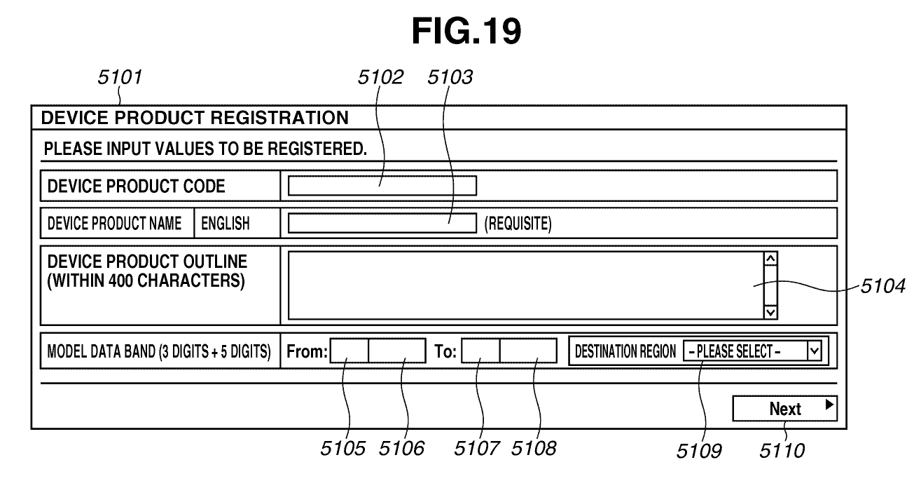

As illustrated in FIG. 19, the license information issuance server 101 displays a device product registration screen 5101 to be used to register a device product. FIG. 19 illustrates an example of the device product registration screen 5101. The device product registration screen 5101 includes input fields for a device product code 5102, a device product name 5103, a product outline 5104, two prefixes 5105 and 5107 of a serial number data band, a starting number 5106 of the serial number data band, and an ending number 5108 of the serial number data band.

The device product registration screen 5101 further includes a destination region list box 5109 to be used to designate a selectable destination region, which is already registered, and a “Next” button 5110 to be selected when the input is completed. In the present embodiment, the “serial number data band” represents a row of device serial numbers, which may be used for the determination of a destination region. The “destination region” indicates a sales region of a device product, an optional product, or an application. The license information issuance server 101 stores a plurality of dealing company's names that are registered beforehand as candidates of the destination region.

In step S502, the user who performs the device product registration sets device product parameters by filling out the input fields displayed on the device product registration screen 5101. In step S503, if the user presses the “Next” button 5110 without performing the input operation appropriately, the license information issuance server 101 displays the same input screen again.

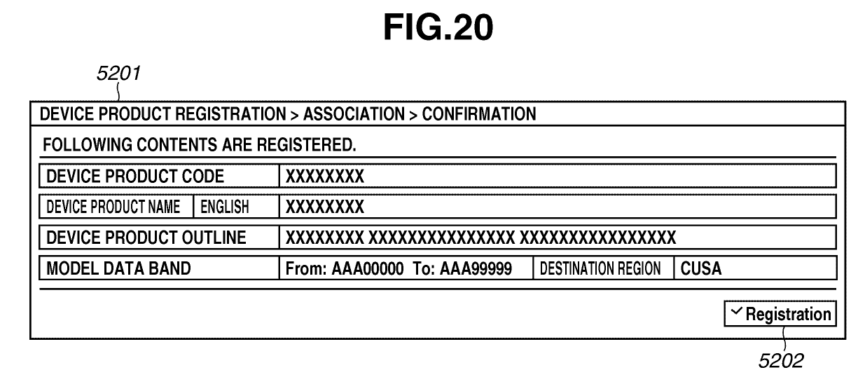

If in step S503 the user performs the input operation appropriately and presses the “Next” button 5110, then in step S504, the license information issuance server 101 displays the setting data on the device product registration confirmation screen 5201 illustrated in FIG. 20. FIG. 20 illustrates an example of the device product registration confirmation screen 5201. In step S505, a user confirms registration contents and presses a “Registration” button 5202. In step S506, the license information issuance server 101 sets the device product information in the DB and terminates the processing of the routine illustrated in FIG. 18.

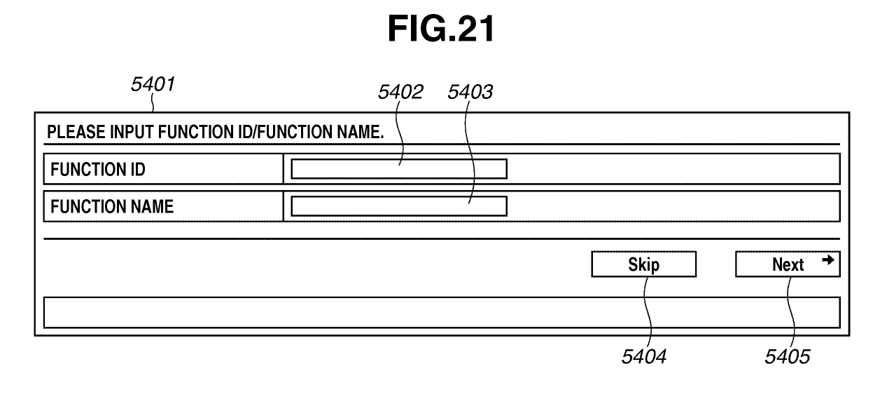

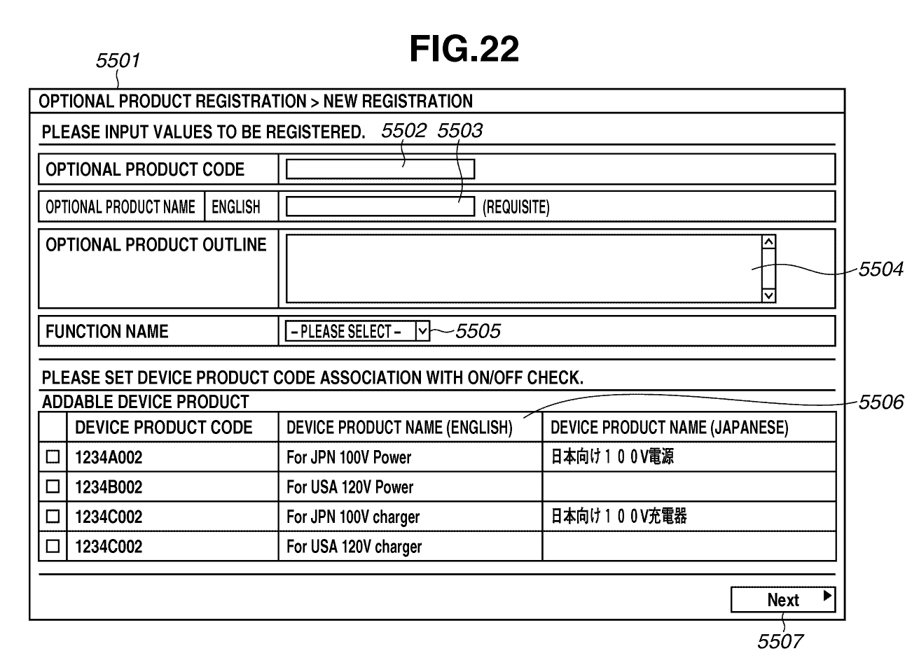

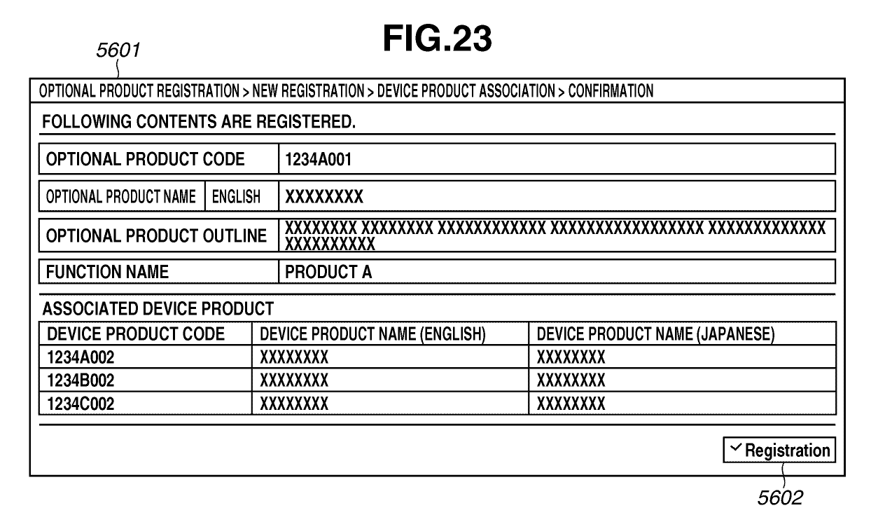

FIGS. 21 to 23 are input screens to be used for registration of an optional product, which are provided by the license information issuance server 101. FIG. 21 illustrates an example of an option registration screen. FIG. 22 illustrates an example of an optional product registration screen. FIG. 23 illustrates an example of an optional product registration confirmation screen.

The license information issuance server 101, in response to an access from the dealing company terminal 103 via the network 105, transmits image data to be used to display the screens illustrated in FIGS. 21 to 23 to the dealing company terminal 103.

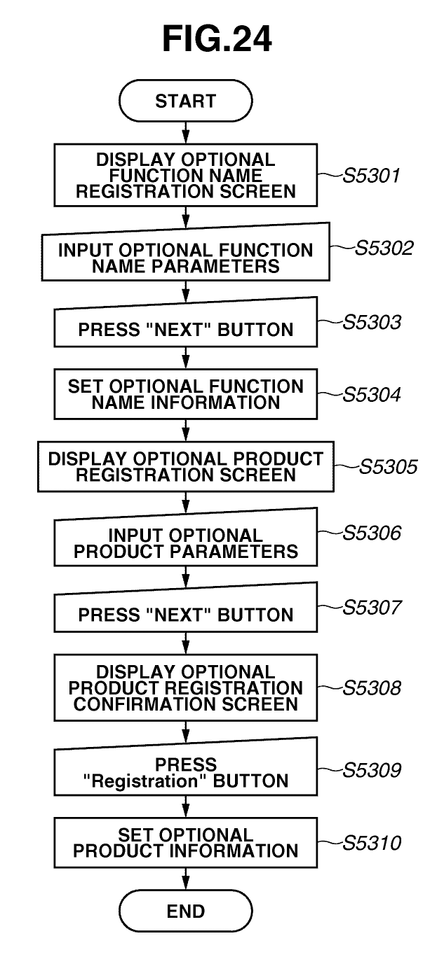

FIG. 24 is a flowchart illustrating an example of optional product registration processing performed by the license information issuance server 101. An example product registration is described below with reference to the flowchart illustrated in FIG. 24 and the screens illustrated in FIGS. 21 to 23. First, a dealing company's operator (hereinafter, simply referred to as “operator”) logs into the license information issuance server 101 from the dealing company terminal 103 via the network 105 to display an operation menu (not illustrated). For example, the menu displayed in this case is a product reference menu in which the operator can perform product registration and refer to or change the registered products.

If the operator selects an item of the product registration on the operation menu (not illustrated), the license information issuance server 101 starts the product registration processing. In step S5301, the license information issuance server 101 displays a new registration screen 5401 to be used to register an optional product. The new registration screen 5401 includes input fields for a function ID 5402 and a function name 5403 as well as a “Next” button 5405 and a “Skip” button 5404. In step S5302, the operator inputs the function ID 5402 and the function name 5403 and selects the “Next” button 5405.

If the input operation is inappropriate at the determination of the “Next” button, the license information issuance server 101 restarts the processing of step S5301. If it is determined that the “Next” button 5405 is pressed, the license information issuance server 101 sets the setting data in the DB. More specifically, in step S5304, the license information issuance server 101 sets optional function name information.

In step S5305, the license information issuance server 101 displays an optional product registration screen 5501. The screen 5501 includes an optional product code input field 5502, an optional product name input field 5503, a product outline input field 5504, and an optional function name selection field 5505. The screen 5501 further includes a device product field 5506 of device products that are already registered and selectable. The operator can select one or more device products listed in the device product field 5506. The screen 5501 further includes a “Next” button 5507 to be selected when the input operation is completed.

In step S5306, the operator inputs information in the optional product code input field 5502, the optional product name input field 5503, the product outline input field 5504, and the optional function name selection field 5505. The operator further inputs information in the already registered and selectable device product field 5506. In step S5307, the operator presses the “Next” button 5507.

If the operator presses the “Next” button 5507 without performing the input operation appropriately, the license information issuance server 101 displays the same input screen again. If the input operation is appropriate, then in step S5308, the license information issuance server 101 displays an optional product registration confirmation screen 5601. Then, in step S5309, the user presses a “Registration” button 5602. In step S5310, the license information issuance server 101 sets the setting data in the DB and then terminates the processing of the routine illustrated in FIG. 24.

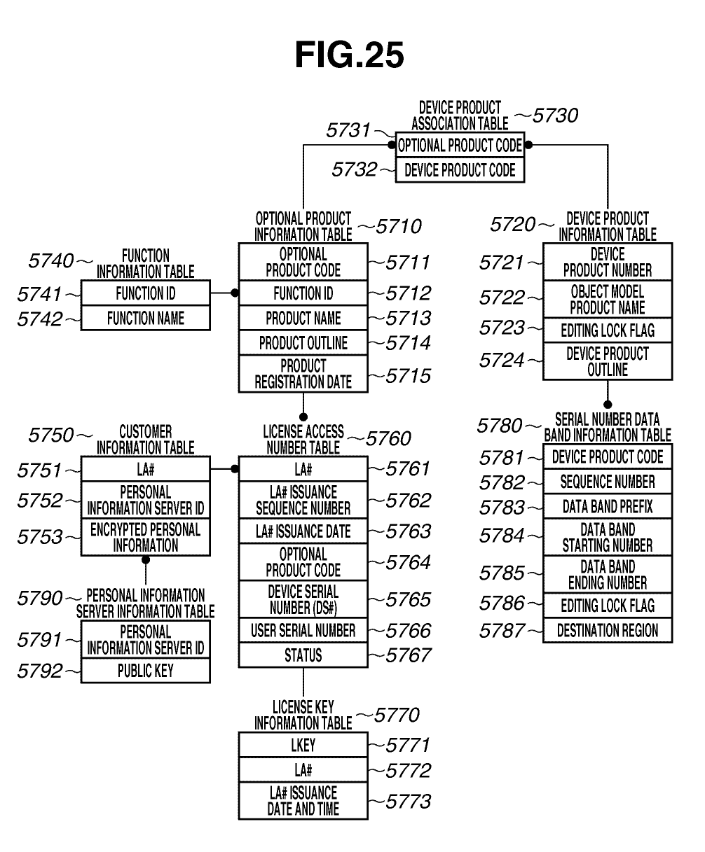

FIG. 25 illustrates information included in the license information management database 106. The license information management database 106 includes an optional product information table 5710, a device product information table 5720, and an optional product-to-device product association table 5730 that associates two information tables 5710 and 5720 because these tables are in a multiple-to-multiple relationship. The license information management database 106 further includes a function information table 5740, a customer information table 5750, a license access number table 5760, and a license key information table 5770. Additionally, the license information management database 106 includes a serial number data band information table 5780 and a personal information server information table 5790.

The function information table 5740 includes a function ID 5741 to be used to classify and identify an option of a printing apparatus and a function name 5742. As the function information and the optional product are in a one-to-multiple relationship, a plurality of license access numbers corresponding to the same optional product can be present.

The optional product information table 5710 includes an optional product code 5711 as a unique value in the system, a function ID 5712 indicating a function classification of an option, a product name 5713, a product outline 5714, and a product registration date 5715.

As the license access number and the optional product is in a one-to-multiple relationship, a plurality of license access numbers corresponding to the same optional product can be present. The license access number table 5760 includes a license access number (LA#) 5761, a license access number issuance sequence number 5762, an LA# issuance date 5763, an optional product code 5764, and a device serial number (DS#) 5765. The license access number table 5760 further includes a user serial number 5766 and a status 5767 indicating a license effective/ineffective state. The customer information table 5750 includes a license access number (LA#) 5751, a personal information server ID 5752, and an encrypted personal information 5753. The personal information server information table 5790 includes a personal information server ID 5791 and a public key 5792.

The license key (Lkey) information table 5770 includes an Lkey 5771, a license access number (LA#) 5772, and an LA# issuance date and time 5773. The device product information table 5720 and the serial number data band information table 5780 are similar to that illustrated in FIG. 16.

The device product information table 5720 includes the device product number 5721 as a unique value in the product, the object model product name 5722, and the editing lock flag 5723 indicating that any change in the contents is inhibited according to an issuance state of LA#. As the serial number data band information table 5780 and the device product information table 5720 are in a one-to-multiple relationship, a plurality of serial number data bands corresponding to the same device product can be present.

The serial number data band information table 5780 includes the device product code 5781, the sequence number 5782, the data band prefix 5783, the data band starting number 5784, and the data band ending number 5785. The serial number data band information table 5780 further includes the editing lock flag 5786 and the destination region 5787. The optional product-to-device product association table 5730 includes an optional product code 5731 and a device product code 5732. As the optional product and the device product are in a one-to-multiple relationship, a plurality of devices product corresponding to the same optional product can be present.

<Issuance of Software Identification Code for Application Product by License Information Issuance Server>

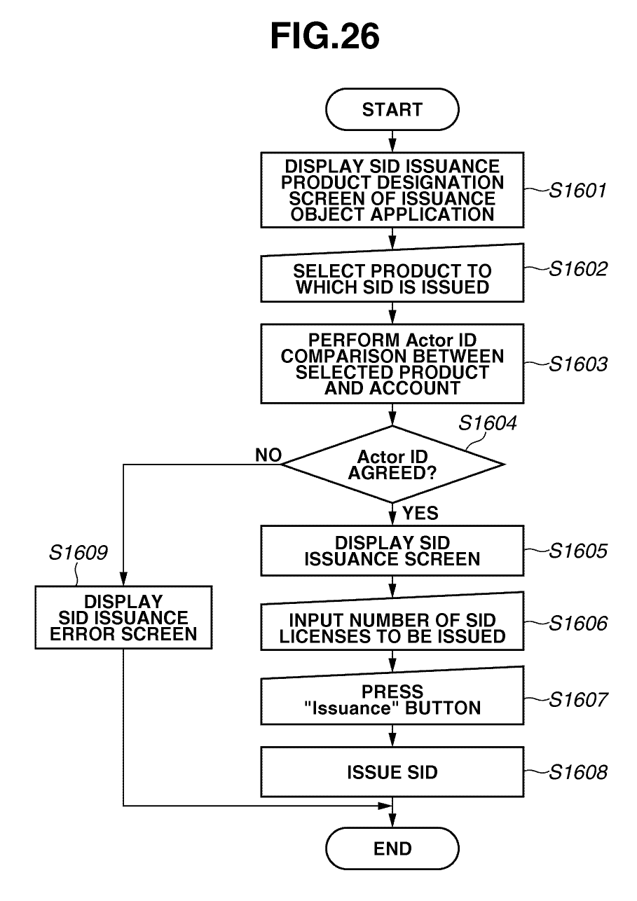

Software identification code issuance processing is described below with reference to a flowchart illustrated in FIG. 26. FIG. 26 is a flowchart illustrating an example of the software identification code issuance processing. The processing of the flowchart illustrated in FIG. 26 is executed in response to a predetermined start operation for the software identification code issuance processing by a dealing company's operator or a software developer's operator (hereinafter, simply referred to as “operator.”) In step S1601, the license information issuance server 101 displays the screen for designating a software identification code issuance product (FIG. 8) for an issuance object application. In step S1602, the license information issuance server 101 accepts a selection of the “SID issuance” button by the operator for a product for which a software identification code is to be issued.

In step S1603, based on an operator's log-in ID and a selected product, the license information issuance server 101 performs an Actor ID comparison between the selected product and an operator account. More specifically, the license information issuance server 101 compares an Actor ID (attribute information of application software) in an application product with an Actor ID of an operator who is performing a software identification code issuance operation when the software identification code is issued. The license information issuance server 101 permits issuance of the software identification code only when the selling entity of the operator who performs a software identification code issuance operation accords with the selling entity of the application software in the application product. The license information issuance server 101 can restrict issuance of a software identification code for an application product if the operator who requests issuance of the software identification code disaccords with the selling entity.

In step S1603, the license information issuance server 101 refers to the databases illustrated in FIGS. 4 and 16, which are registered beforehand. More specifically, the license information issuance server 101 acquires the actor ID 20102 in the account table 20100 as the actor ID of the software operator. The license information issuance server 101 further searches for an application registration number of the application table 1401 that is consistent with the application registration number 1409 of the product table 1407. Then, the license information issuance server 101 acquires the actor ID of the product by acquiring the actor ID of the above-described record.

In step S1604, the license information issuance server 101 compares the actor ID of the operator with the actor ID of the selected product. If the compared actor IDs are not consistent with each other, then in step S1609, the license information issuance server 101 displays an SID issuance error screen (not illustrated) and terminates the processing of the routine illustrated in FIG. 26.

If in step S1604 the actor ID of the operator is consistent with the actor ID of the selected product, then in step S1605, the license information issuance server 101 displays the software identification code issuance screen (FIG. 9).

In step S1606, the license information issuance server 101 accepts an input of the number of licenses for the software identification code that the operator issues. In step S1607, the license information issuance server 101 accepts a selection of the “Issuance” button. If the “Issuance” button is selected, then in step S1608, the license information issuance server 101 issues the software identification code and terminates the processing of the routine illustrated in FIG. 26.

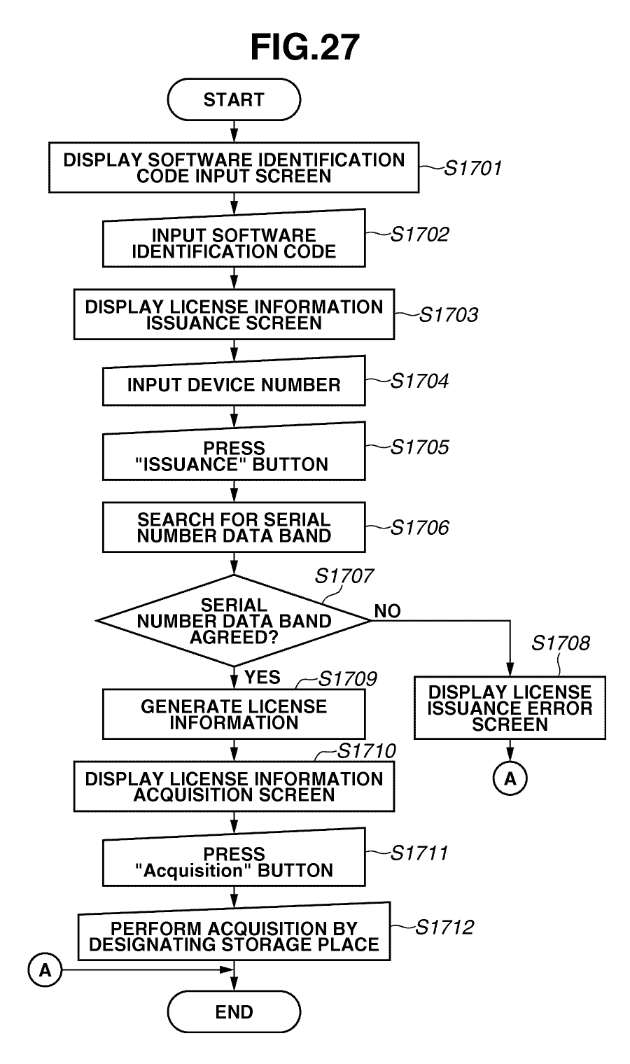

License information issuance processing performed in response to a request from the user is described with reference to a flowchart illustrated in FIG. 27. FIG. 27 is a flowchart illustrating an example of the license information issuance processing performed in response to a request from the user.

The processing of the flowchart illustrated in FIG. 27 is executed in response to a predetermined start operation for the license information issuance processing by the user. In step S1701, the license information issuance server 101 displays the software identification code input screen (FIG. 10) on a display apparatus of the user terminal. In step S1702, the license information issuance server 101 accepts an input of a software identification code entered by the user. If the software identification code is input, then in step S1703, the license information issuance server 101 displays the license information issuance screen (FIG. 11).

In step S1704, the license information issuance server 101 accepts an input of a device serial number entered by the user. If the input of the device serial number is completed, then in step S1705, the user selects the “Issuance” button to instruct issuance of license information (file). In step S1706, the license information issuance server 101 performs search for a serial number data band based on the entered software identification code and the device serial number. The license information issuance server 101 determines whether the device serial number entered by the user for issuance of the license information is present in a serial number data band corresponding to the software identification code entered by the user for issuance of the license information. The license information issuance server 101 restricts issuance of the license information to prevent an application for a specific destination region from being erroneously installed on a device for another destination region.

In step S1706, the license information issuance server 101 refers to the database illustrated in FIG. 16, which is registered beforehand. More specifically, the license information issuance server 101 searches the software identification code table 1420 for the software identification code entered by the user and refers to the product code 1422 based on the searched record.

The license information issuance server 101 further refers to the product table 1407 based on the product code and searches for a record that accords with the product code. At the same time, the license information issuance server 101 searches the application table 1401 for the application registration number 1402 and the application ID 1403. The license information issuance server 101 specifies the application ID 5811 of the application ID-to-device product code association table and searches for the device product code 5812 referring to the application ID 5811. The license information issuance server 101 further searches the serial number data band information table 5780 for the data band starting number 5784 and the data band ending number 5785 referring to the device product code 5812.

The license information issuance server 101 acquires the data band starting number 5784 and the data band ending number 5785 corresponding to the software identification code entered by the user. In step S1707, the license information issuance server 101 determines whether the device serial number entered by the user is present between the data band starting number 5784 and the data band ending number 5785 of the searched serial number data band information table 5780. If the device serial number entered by the user is present between the data band starting number 5784 and the data band ending number 5785, issuance of the license information is feasible. If the device serial number entered by the user is not present between the data band starting number 5784 and the data band ending number 5785, then in step S1708, the license information issuance server 101 displays the license issuance error screen. Then, the license information issuance server 101 terminates the processing of the routine illustrated in FIG. 27.

In step S1709, the license information issuance server 101 generates the license information. In step S1710, the license information issuance server 101 displays the license information acquisition screen (FIG. 12). In step S1711, the user selects the “Acquisition” button to acquire the generated license information. In step S1712, a storage dialog standardized for the operating system is displayed. The user inputs an arbitrary storage destination and a file name to store the license information. Then, the license information issuance server 101 terminates the processing of the routine illustrated in FIG. 27.

In the present embodiment, the license information issuance server 101 directly issues the license information for the user. However, the license information issuance server 101 may issue license information for the software developer. The software developer may transfer the issued license information to the user.

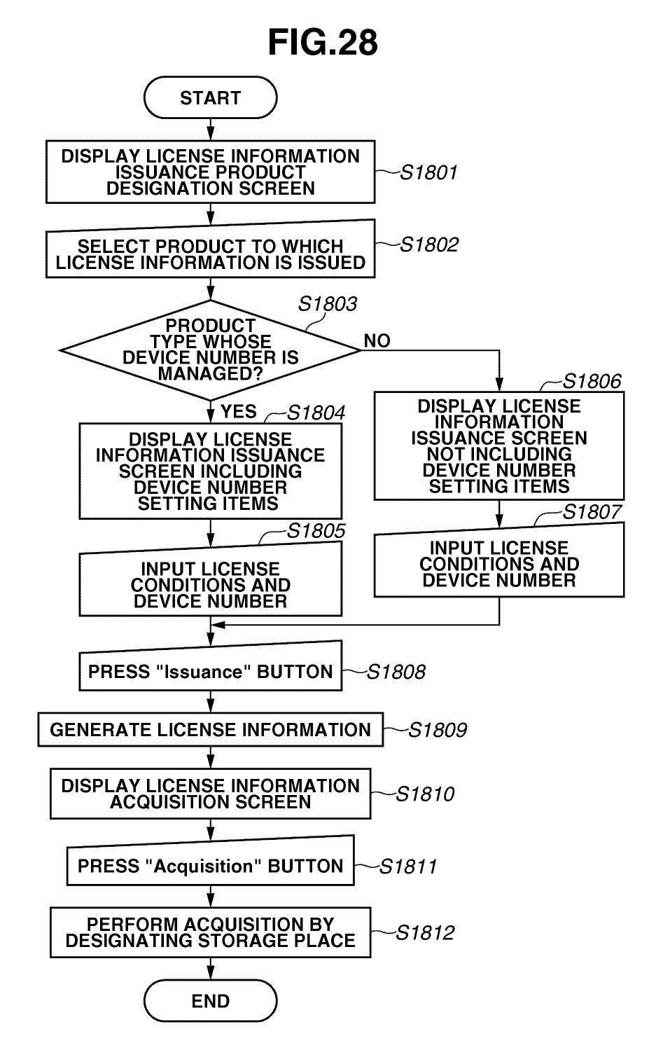

License information issuance processing performed in response to a request from the dealing company or the software developer is described below with reference to a flowchart illustrated in FIG. 28. FIG. 28 is a flowchart illustrating the license information issuance processing performed in response to a request from the dealing company or the software developer.

The processing of the flowchart illustrated in FIG. 28 is executed in response to a predetermined start operation for the license information issuance processing by a dealing company's operator or a software developer's operator (hereinafter, simply referred to as “operator”). In step S1801, the license information issuance server 101 displays the license information issuance product designation screen (FIG. 14) for an issuance object application.

In step S1802, the license information issuance server 101 accepts an operator's selection of the “LF Issuance” button of a product for which the license information is issued. In step S1803, the license information issuance server 101 determines whether the product type of the product selected by the “LF Issuance” button is a product whose device serial number is managed. If the product type is the product whose device serial number is managed, then in step S1804, the license information issuance server 101 displays the license information issuance screen (FIG. 15) that includes the device serial number setting item. In step S1805, the license information issuance server 101 accepts license conditions and a device serial number entered by the operator. Then, the processing proceeds to step S1808.

If in step S1803 the product type of the product selected by the “LF Issuance” button is not the product whose device serial number is managed, then in S1806, the license information issuance server 101 displays a license information issuance screen that does not include the device serial number setting item.

In step S1807, the license information issuance server 101 accepts license conditions entered by the operator. The processing then proceeds to step S1808. In step S1808, the license information issuance server 101 accepts a selection of the “Issuance” button by the operator. If the “Issuance” button is selected, then in step S1809, the license information issuance server 101 generates license information. In step S1810, the license information issuance server 101 displays the license information acquisition screen (FIG. 12).

In step S1811, the operator selects the “Acquisition” button to acquire the generated license information. In step S1812, a storage dialog standardized for the operating system is displayed. The operator stores an arbitrary storage destination and a file name to store the license information. The license information issuance server 101 terminates the processing of the routine illustrated in FIG. 28.

In the present embodiment, the user can receive an authentication based on the license information issued in the above-described manner. The user can install an application product on a user's device and can add a device function. Executing authentication based on the license information can prevent the application product from being inappropriately copied or installed.

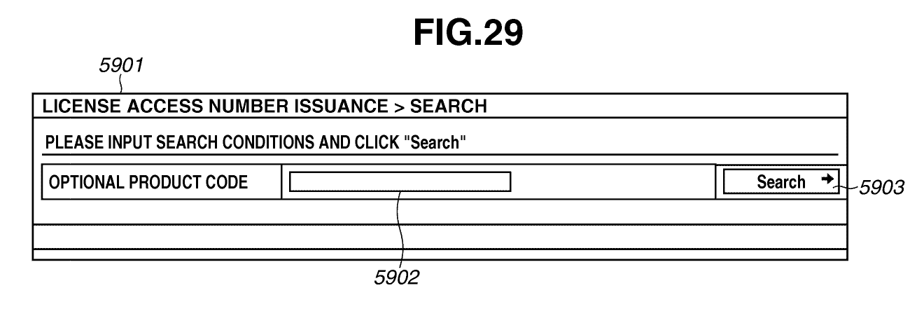

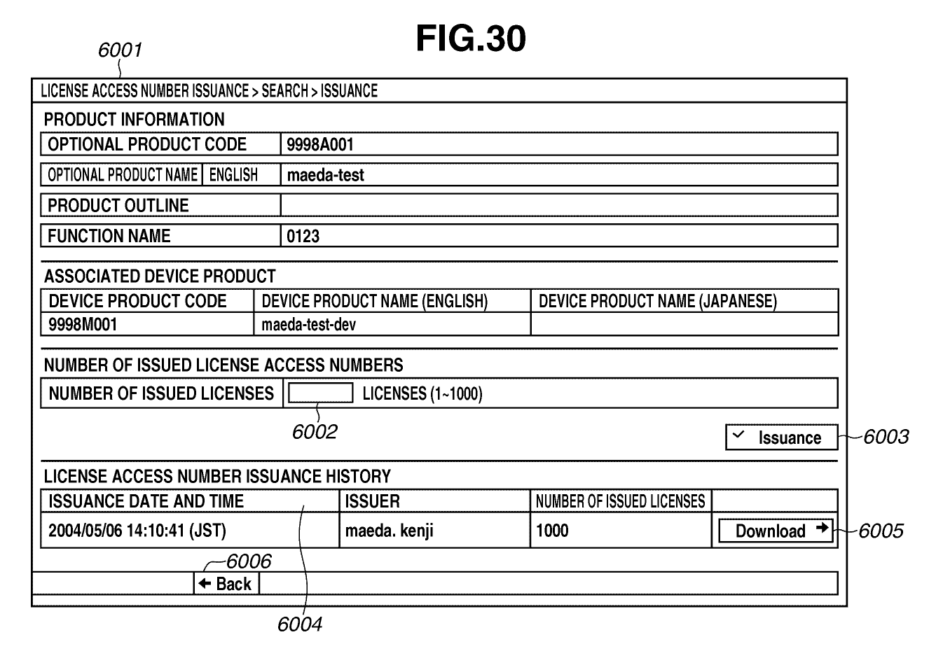

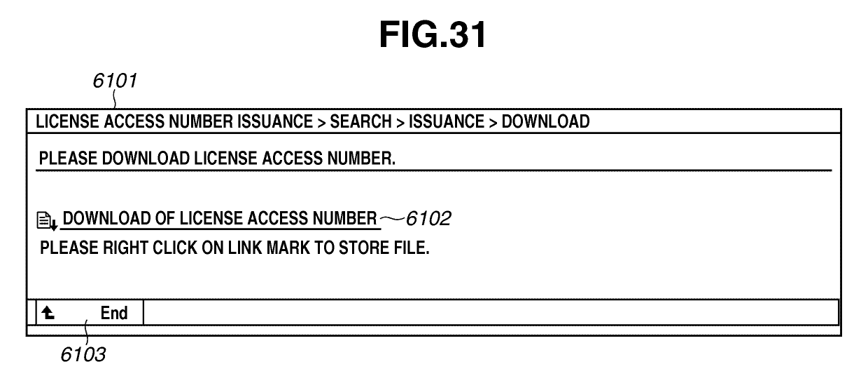

FIGS. 29 to 31 illustrate screens to be used to issue a license access number. FIG. 29 illustrates an example of an optional product search screen to be used for issuance of the LA#. FIG. 30 illustrates an example of an optional information display screen to be used for issuance of the LA#. FIG. 31 illustrates an example of a download screen to be used for issuance of the LA#.

The license information issuance server 101, in response to access from the software developer terminal 104 via the network 105, transmits the image data to be used to display the screens illustrated in FIGS. 29 to 31 to the software developer terminal 104.

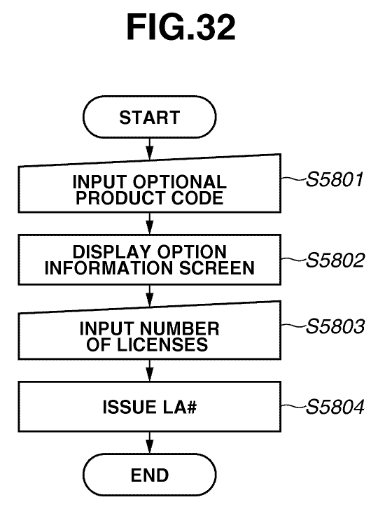

FIG. 32 is a flowchart illustrating an example of control processing performed by the LA# issuance unit. Issuance of a license access number is described below with reference to the flowchart illustrated in FIG. 32 and the screens illustrated in FIGS. 29 to 31. In step S5801, the license information issuance server 101 transmits image data to be used to display a screen 5901 illustrated in FIG. 29 that requests a user to input an optional product code. The screen 5901 includes an option number input field 5902 and a “Search” button 5903.

If the user presses the “Search” button 5903, then in step S5802, the license information issuance server 101 displays an option information screen 6001 illustrated in FIG. 30. More specifically, the license information issuance server 101 acquires an optional product code, extracts information relating to the optional product code (information relating to the option) from the database, and generates screen information. In addition to the information relating to the option, the option information screen 6001 includes a field 6002 to be used to designate the number of issued license access numbers (LA#), an “Issuance” button 6003, and an issuance history display 6004. The option information screen 6001 further includes a “Download” button 6005 for a license access number already issued and a “Back” button 6006.

If the “Issuance” button 6003 is pressed, then in step S5803, the license information issuance server 101 performs LA# issuance processing and generates a license number download screen 6101 illustrated in FIG. 31 that requests the user to instruct issuance of the license. In step S5804, the license information issuance server 101 performs the LA# issuance processing, acquires the input issuance number, and generates license access tables corresponding to the issuance number. At the same time, the license information issuance server 101 generates a license access number and sets the generated number for the table. The license information issuance server 101 further stores a file of the generated data. The license information issuance server 101 prepares display data including a link to the generated file.

The download screen 6101 includes a “download of license access number” link 6102 and an “End” button 6103 to be selected to terminate the processing. If the “Download” button 6005 is pressed to re-issue the license access number, then in step S5804, the license information issuance server 101 performs the LA# issuance processing and generates the license number download screen 6101. The license information issuance server 101 prepares the display data including a link to the stored and previously generated file.

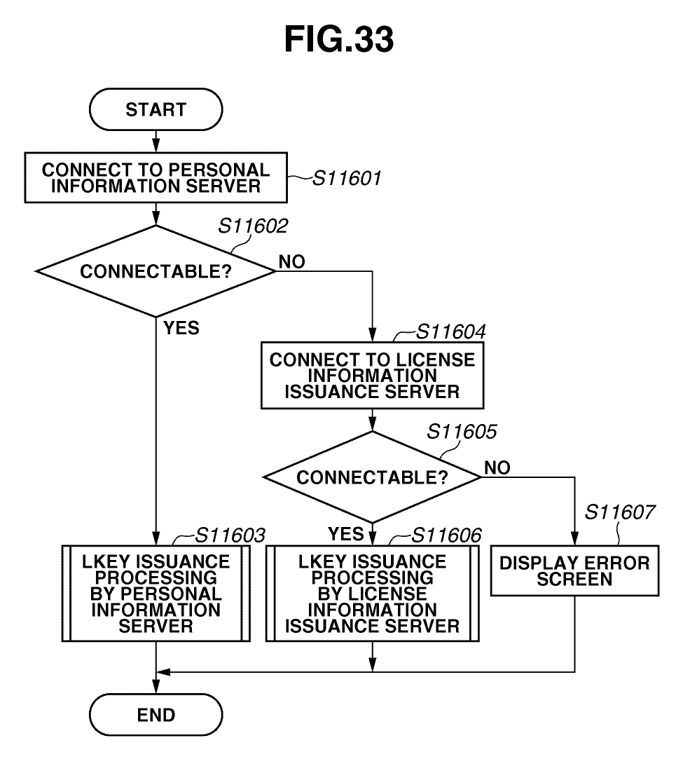

FIG. 33 is a flowchart illustrating an example of processing performed by the user terminal 102, when a license key for an optional product is issued. To perform issuance of license information, the user accesses the URL of the personal information server 180 described in the purchased option package via a browser of the user terminal 102. The URL of the personal information server 180 may be different depending on a region where the option package is purchased. In step S11601, the user terminal 102 attempts to secure a connection to the personal information server 180. If in step S11602 the user terminal 102 is connectable to the personal information server 180, the processing proceeds to step S11603. If the user terminal 102 is not connectable to the personal information server 180, the processing proceeds to step S11604.

In step S11603, the personal information server 180 performs LKey issuance processing as described below. In step S11604, the user accesses the URL of the license information issuance server 101 described in the purchased option package via the browser of the user terminal 102 and attempts to secure a connection to the license information issuance server 101. If in step S11605 the user terminal 102 is connectable to the license information issuance server 101, the processing proceeds to step S11606. If the user terminal 102 is not connectable to the license information issuance server 101, the processing proceeds to step S11607. In step S11606, the license information issuance server 101 performs LKey issuance processing. In step S11607, the browser of the user terminal 102 displays an error screen indicating failure in connection. The user terminal 102 terminates the processing of the routine illustrated in FIG. 33.

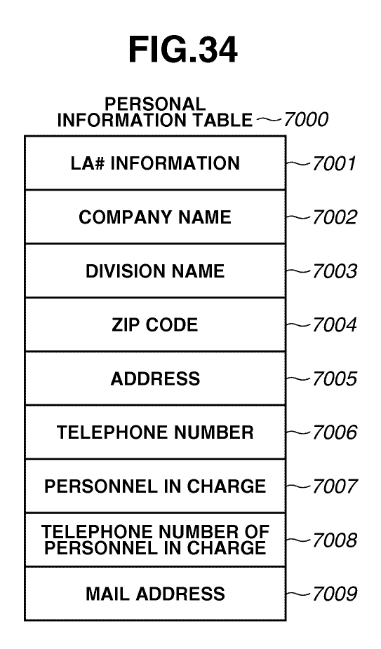

FIG. 34 illustrates an example of information included in the personal information database 195. The personal information database 195 includes a personal information table 7000. The personal information table 7000 includes personal information entered via the user terminal 102 when the license for an optional product is issued. More specifically, the personal information table 7000 includes LA# information 7001, a company name 7002, a division name 7003, a zip code 7004, and an address 7005. The personal information table 7000 further includes a telephone number 7006, a personnel-in-charge name 7007, a personnel-in-charge telephone number 7008, and a mail address 7009.

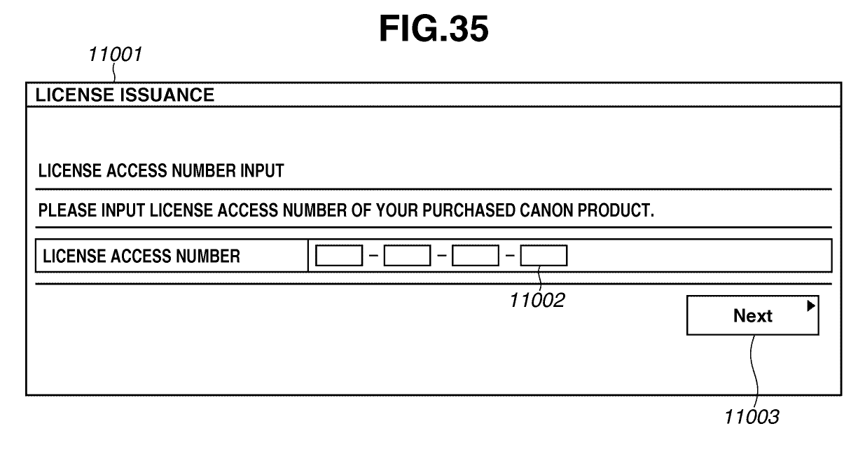

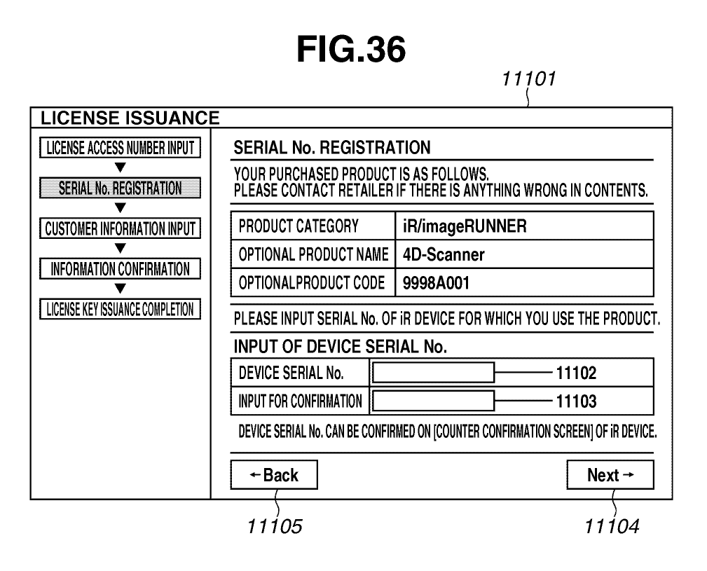

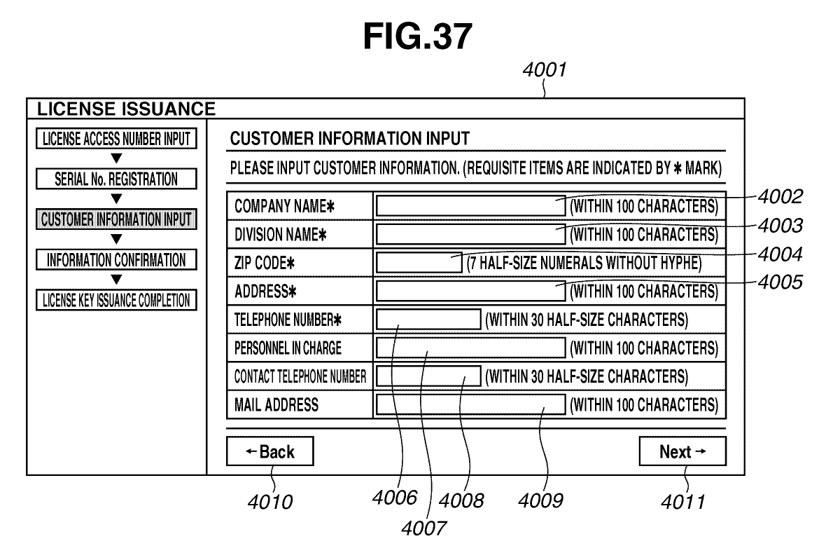

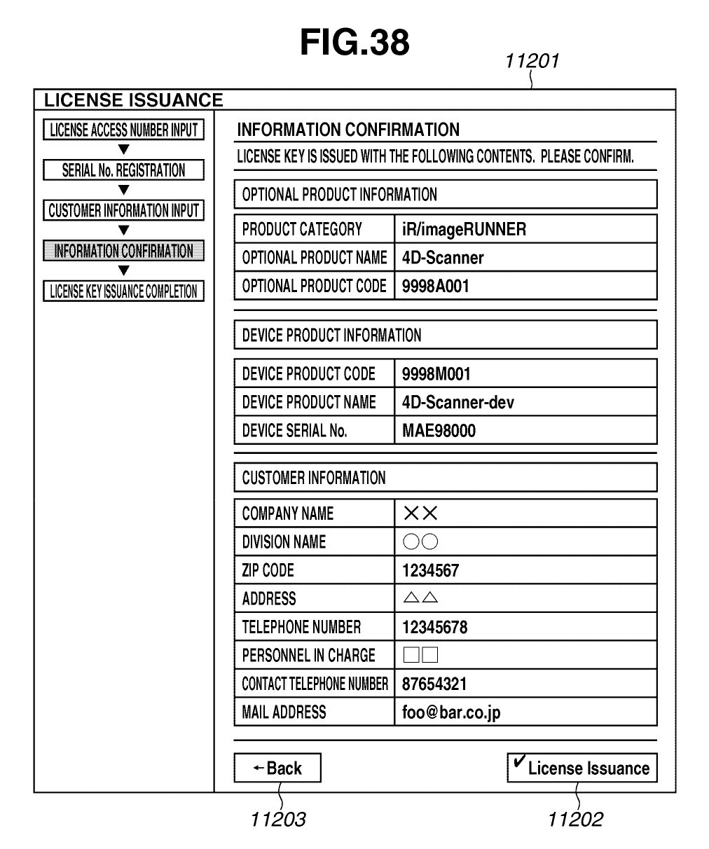

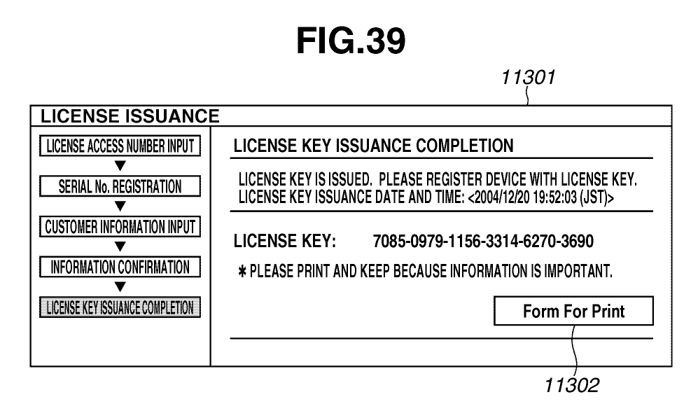

FIGS. 35 to 39 illustrate screens to be used to issue a license key. FIG. 35 illustrates an example of a license access number input screen usable for license key issuance processing. FIG. 36 illustrates an example of a device serial number input screen usable for license key issuance processing. FIG. 37 illustrates an example of a personal information input screen usable for personal information input processing of license key issuance processing. FIG. 38 illustrates an example of an information confirmation screen usable for license key issuance processing. FIG. 39 illustrates an example of a license key issuance completion screen usable for license key issuance processing. If the personal information server 180 is operating, the user terminal 102 accesses the personal information server 180 to perform processing for issuing a license key of the optional product.

The personal information server 180, in response to access from the user terminal 102 via the network 105, transmits image data to be used to display the screens illustrated in FIGS. 35 to 39 to the user terminal 102.

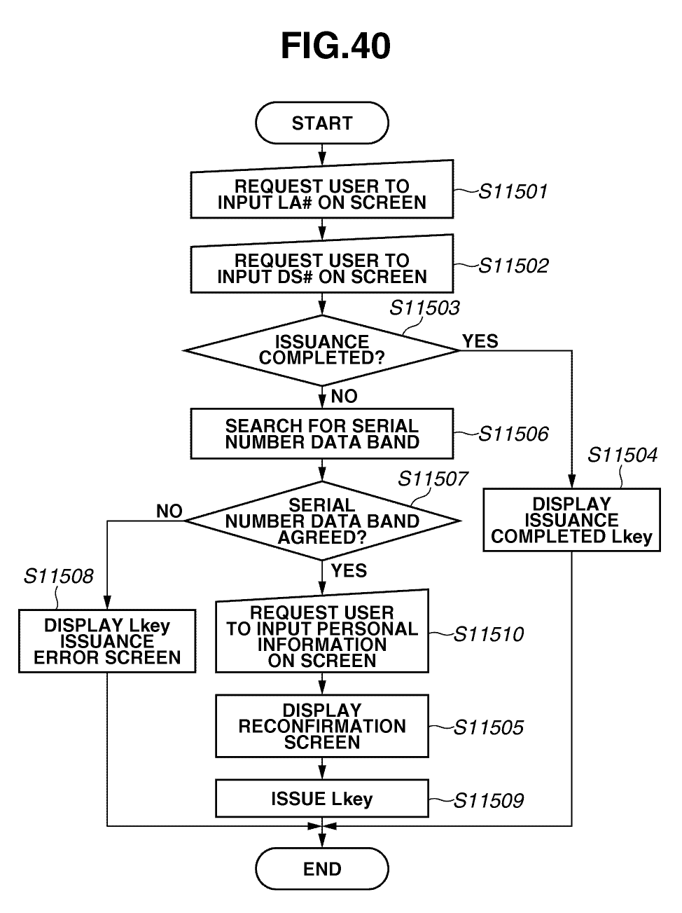

FIG. 40 is a flowchart illustrating an example of license key issuance processing performed by the personal information server 180. License key issuance processing performed by the personal information server 180 is described below with reference to the flowchart illustrated in FIG. 40 and the display screens illustrated in FIGS. 35 to 39. To perform issuance of license information, a user accesses the URL of the personal information server 180 described in a purchased option package via the browser of the user terminal 102. If the personal information server 180 receives a request, then in step S11501, the personal information server 180 performs processing for generating an access number input screen 11001.

Then, the personal information server 180 transmits the generated image data to the user terminal 102 and requests the user to input a license access number (LA#). The access number input screen 11001 includes a license access number (LA#) input field 11002 and a “Next” button 11003.

The user inputs the license access number (LA#) described in the purchased option package to the input field 11002 and presses the “Next” button 11003. In step S11502, the personal information server 180 acquires the entered license access number (LA#). The personal information server 180, using the RPC module 194 of the RPC function unit 193, communicates with the RPC module 176 of the RPC function unit 175 in the license information issuance server 101. The personal information server 180 searches the license information management database 106 for the license access number table 5760 and extracts information relating to the set option and information relating to the product. The personal information server 180 generates information for a registration screen 11101 that requests the user to input a serial number.

The registration screen 11101 includes a device serial number input field 11102, an “input for confirmation” field 11103, a “Next” button 11104, and a “Back” button 11105. If the user inputs information (device serial number) in these fields and presses the “Next” button 11104, the personal information server 180 executes the processing of step S11503. In step S11503, the personal information server 180, using the RPC function of the RPC function unit 193, communicates with the RPC module 176 of the RPC function unit 175 in the license information issuance server 101. The personal information server 180 refers to the database illustrated in FIG. 25, which is registered beforehand in the license information management database 106, and confirms the entered device serial number. The personal information server 180 determines whether the entered device serial number is for an issuance completed device.

If the determination result indicates that the license is not issued, the personal information server 180 performs the processing of step S11505. In step S11505, the personal information server 180 displays an information confirmation screen 11201 illustrated in FIG. 38 that requests the user to confirm the issued license. The information confirmation screen 11201 includes a “License Issuance” button 11202 and a “Back” button 11203.

If the “License Issuance” button 11202 is pressed, then in step S11506, the personal information server 180, using the RPC module 194 of the RPC function unit 193, communicates with the RPC module 176 of the RPC function unit 175 in the license information issuance server 101. The personal information server 180 refers to the database illustrated in FIG. 25, which is registered beforehand in the license information management database 106, and performs search for a serial number data band based on the entered software identification code and the device serial number.

In the search for a serial number data band, the personal information server 180 determines whether the device serial number entered by the user for issuance of the license key is present in the serial number data band corresponding to the license access number (LA#) entered by the user for issuance of the license key. The personal information server 180 restricts issuance of the license key so as to prevent an optional product for a specific destination region from becoming effective in a device for another destination region.

In the processing of step S11506, the personal information server 180, using the RPC module 194 of the RPC function unit 193, communicates with the RPC module 176 of the RPC function unit 175 in the license information issuance server 101. The personal information server 180 refers to the database illustrated in FIG. 25, which is registered beforehand, in the license information management database 106 of the license information issuance server 101. More specifically, the personal information server 180 searches the license access number table 5760 for the license access number (LA#) entered by the user and refers to the optional product code 5764 of the searched record.

The personal information server 180 further refers to the optional product information table 5710 based on the optional product code and searches for a record that is consistent with the optional product code. The personal information server 180 searches for the device product code 5732 referring to the optional product code 5731 of the optional product-to-device product association table 5730. The personal information server 180 further searches the device product information table 5720 for the device product number 5721 referring to the device product code 5732, and also searches the serial number data band information table 5780 for the data band starting number 5784 and the data band ending number 5785. Through the above-described processing, the personal information server 180 acquires the data band starting number 5784 and the data band ending number 5785 corresponding to the license access number (LA#) entered by the user.

In step S11507, the personal information server 180 determines whether the device serial number entered by the user is present between the data band starting number 5784 and the data band ending number 5785 of the searched serial number data band information table 5780. If the device serial number entered by the user is present between the data band starting number 5784 and the data band ending number 5785, issuance of the license key is feasible.

If in step S11507 the device serial number entered by the user is not present between the data band starting number 5784 and the data band ending number 5785, the processing proceeds to step S11508. In step S11508, the personal information server 180 displays the license issuance error screen (not illustrated). The personal information server 180 terminates the processing of the routine illustrated in FIG. 40.

If in step S11507 the personal information server 180 determines that the license key can be issued, the processing proceeds to step S11510. In step S11510, the personal information server 180 performs processing for generating a personal information input screen 4001 that requests the user to input information for registration of personal information. The personal information server 180, using the function of the personal information registration unit 181, registers the personal information, URL argument, or LA# entered by the user for issuance of the license key acquired using a cookie, in the personal information database 195. Additionally, using the encryption module 183 of the personal information registration unit 181, the personal information server 180 generates encrypted personal information based on the personal information.

Using the RPC module 194 of the RPC function unit 193, the personal information server 180 communicates with the RPC module 176 of the RPC function unit 175 in the license information issuance server 101. The personal information server 180 registers the encrypted personal information in the database illustrated in FIG. 25, which is registered beforehand and corresponds to the LA# entered by the user for issuance of the license key, in the license information management database 106 of the license information issuance server 101.

The RSA public key encryption algorithm is available for the encryption used by the encryption module 183. The key generation module 182 can generate a pair of a public key and a secret (private) key when the personal information server 180 starts its service. The key registration module 186 stores the generated pair of the public key and the secret key in a file system of the personal information server 180. The encryption key transmission module 187 transmits the public key to be used to encrypt the stored personal information together with the URL of the personal information server 180 to the license information issuance server 101, which is registered beforehand.

The encryption key reception module 172 of the encrypted personal information registration unit 170 in the license information issuance server 101 receives the transmitted URL of the personal information server 180 and the public key to be used to encrypt the personal information. The encryption key registration module 171 stores the URL of the personal information server 180 in the personal information server ID 5791 of the personal information server information table 5790 in the license information management database 106. The encryption key registration module 171 further stores the public key to be used to encrypt the personal information in the public key 5792 of the personal information server information table 5790 in the license information management database 106.

The personal information input screen 4001 illustrated in FIG. 37 includes a company name input field 4002, a division name input field 4003, a zip code input field 4004, an address input field 4005, a telephone number input field 4006, and a personnel-in-charge name input field 4007. The personal information input screen 4001 further includes a personnel-in-charge telephone number input field 4008, a mail address input field 4009, a “Back” button 4010, and a “Next” button 4011.

The user inputs a company name, a division name, a zip code, an address, a telephone number, a personnel-in-charge name, a personnel-in-charge telephone number, and a mail address in respective input fields on the personal information input screen 4001, and presses the “Next” button 4011. The personal information server 180 registers the contents entered in the personal information table 7000 illustrated in FIG. 34. The personal information server 180 uses the encryption module 183 of the personal information registration unit 181 to convert the input contents of the fields 4002 to 4009 entered by the user into a CSV file and encrypts the file with an encryption key registered beforehand. The personal information server 180, using the RPC module 194 of the RPC function unit 193, communicates with the RPC module 176 of the RPC function unit 175 in the license information issuance server 101. The personal information server 180 registers the encrypted personal information in the database (see FIG. 25) of the license information management database 106, which is registered beforehand.

If in step S11507 the personal information server 180 determines that the license key can be issued, the processing proceeds to step S11509. In step S11509, the personal information server 180 generates an encrypted license key number (Lkey#) based on the entered device serial number and the option number being set. The personal information server 180, using the RPC module 194 of the RPC function unit 193, communicates with the RPC module 176 of the RPC function unit 175 in the license information issuance server 101. The personal information server 180 registers the encrypted license key number in the database (see FIG. 25) of the license information management database 106. The personal information server 180 further generates a screen 11301 illustrated in FIG. 39 that displays the license key number (Lkey#). The screen 11301 includes a button 11302 to be selected to generate a screen having an appropriate size for printing via the browser.

If in step S11503 it is determined that the issuance is already completed, the personal information server 180 performs the processing of step S11504. In step S11504, the personal information server 180, using the RPC module 194 of the RPC function unit 193, communicates with the RPC module 176 of the RPC function unit 175 in the license information issuance server 101. The personal information server 180 acquires the already encrypted license key number (Lkey#) from the database (see FIG. 25) of the license information management database 106 based on the entered device serial number and the option number being set. The personal information server 180 further generates the screen 11301 that displays the already acquired license key number (Lkey#).

The user may input the acquired license key to a device such as a printing apparatus. As a result, the option can be used on the printing apparatus. The device, when the license key is input, generates a license key number (Lkey#) based on its own device serial number and the option number being set. The device permits activation of the option based on a determination result as to whether the input license key number (Lkey#) is consistent with the license key number (Lkey#) generated by the device. Through the above-described procedure, the license information issuance server 101 can manage each manufactured and sold device and its option(s).

The above-described device may be different from the user terminal 102 or can be a system including the device integrated with the user terminal 102 if the system enables users to input the license key (Lkey#) under operation of a browser. In the above-described procedure, the processing order of the optional product registration and the device registration can be switched arbitrarily.

If the user terminal 102 cannot communicate with the personal information server 180, the user terminal 102 accesses the license information issuance server 101 to perform license key issuance processing for the optional product.

The license information issuance server 101, in response to an access from the user terminal 102 via the network 105, transmits image data to be used to display the screens illustrated in FIGS. 35 to 39 to the user terminal 102. The access from the user terminal 102 can be realized, using the URL of the personal information server 180 that was unconnectable.

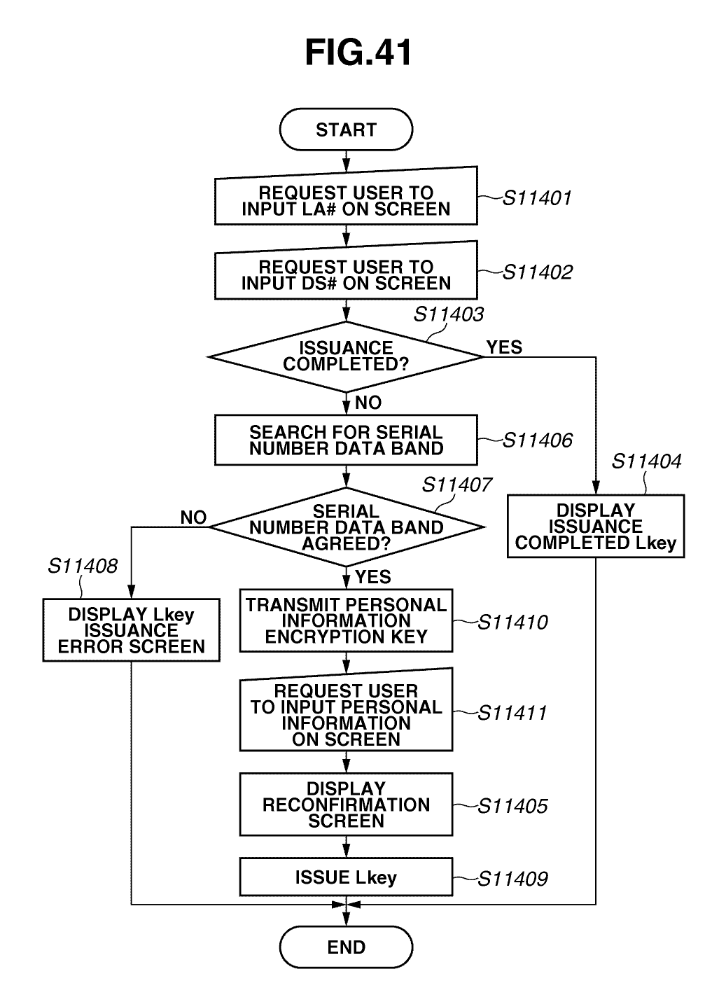

FIG. 41 is a flowchart illustrating an example of license key issuance processing performed by the license information issuance server 101. License key issuance processing is described below with reference to the flowchart illustrated in FIG. 41 and the screens illustrated in FIGS. 35 to 39. The user, who performs issuance of license information, accesses the URL described in the purchased option package via the browser of the user terminal 102. If the license information issuance server 101 receives a request from the user, then in step S11401, the license information issuance server 101 performs processing for generating the access number input screen 11001.

The license information issuance server 101 transmits the generated image data to the user terminal 102 and requests the user to input a license access number (LA#). The access number input screen 11001 includes the license access number (LA#) input field 11002 and the “Next” button 11003.

The user inputs the license access number (LA#) described in the purchased option package to the input field 11002 and presses the “Next” button 11003. In step S11402, the license information issuance server 101 acquires the entered license access number (LA#). The license information issuance server 101 searches the license access number table 5760 and extracts information relating to the option being set and information relating to the product. The license information issuance server 101 generates information for the registration screen 11101 that requests the user to input a serial number.

The registration screen 11101 includes the device serial number input field 11102, the “input for confirmation” field 11103, the “Next” button 11104, and the “Back” button 11105. If the user inputs the device serial number in these fields and presses the “Next” button 11104, the license information issuance server 101 executes the processing of step S11403. In step S11403, the license information issuance server 101 confirms the entered device serial number and determines whether the entered device serial number is for an issuance completed device.

If the determination result indicates that the license is not issued, the license information issuance server 101 performs the processing of step S11405. In step S11405, the license information issuance server 101 displays the information confirmation screen 11201 illustrated in FIG. 38 that requests the user to confirm the issued license. The information confirmation screen 11201 includes the “License Issuance” button 11202 and the “Back” button 11203.

If the “License Issuance” button 11202 is pressed, then in step S11406, the license information issuance server 101 performs search for a serial number data band based on the entered software identification code and the device serial number. In the search for a serial number data band, the license information issuance server 101 determines whether the device serial number entered by the user for issuance of the license key is present in the serial number data band corresponding to the license access number (LA#) entered by the user for issuance of the license key. Through the above-described procedure, the license information issuance server 101 restricts issuance of the license key to prevent an optional product for a specific destination region from becoming effective in a device for another destination region.

In the processing of step S11406, the license information issuance server 101 refers to the database illustrated in FIG. 25, which is registered beforehand. The license information issuance server 101 searches the license access number table 5760 for the license access number (LA#) entered by the user and refers to the optional product code 5764 of the searched record. The license information issuance server 101 further refers to the optional product information table 5710 based on the optional product code and searches for a record that is consistent with the optional product code.

The license information issuance server 101 searches for the device product code 5732 referring to the optional product code 5731 of the optional product-to-device product association table 5730. The license information issuance server 101 further searches the device product information table 5720 for the device product number 5721 referring to the device product code 5732, and also searches the serial number data band information table 5780 for the data band starting number 5784 and the data band ending number 5785. Through the above-described processing, the license information issuance server 101 acquires the data band starting number 5784 and the data band ending number 5785 corresponding to the license access number (LA#) entered by the user.

In step S11407, the license information issuance server 101 determines whether the device serial number entered by the user is present between the data band starting number 5784 and the data band ending number 5785 of the searched serial number data band information table 5780. If the device serial number entered by the user is present between the data band starting number 5784 and the data band ending number 5785, issuance of the license key is feasible.

If in step S11407 the device serial number entered by the user is not present between the data band starting number 5784 and the data band ending number 5785, the license information issuance server 101 displays the license issuance error screen. The license information issuance server 101 terminates the processing of the routine illustrated in FIG. 41.

If in step S11407 the license information issuance server 101 determines that the license key can be issued, the processing proceeds to step S11410. In step S11410, the license information issuance server 101 transmits an encryption key, which corresponds to a personal information server URL given according to an argument of the URL received from the user terminal 102, to the user terminal 102. In step S11411, the license information issuance server 101 performs processing for generating the personal information input screen 4001 that includes a Java® Script required for decoding and requests the user to register personal information. The user terminal 102 receives the encryption key transmitted from the license information issuance server 101, encrypts the personal information entered on the personal information input screen 4001 with the received encryption key, and transmits the encrypted personal information to the license information issuance server 101.

The license information issuance server 101 registers the encrypted personal information, which was encrypted by the user terminal 102 with the encryption key, in the license information management database 106. The personal information input screen 4001 includes the company name input field 4002, the division name input field 4003, the zip code input field 4004, the address input field 4005, the telephone number input field 4006, and the personnel-in-charge name input field 4007. The personal information input screen 4001 further includes the personnel-in-charge telephone number input field 4008, the mail address input field 4009, the “Back” button 4010, and the “Next” button 4011.

The user inputs a company name, a division name, a zip code, an address, a telephone number, a personnel-in-charge name, a personnel-in-charge telephone number, and a mail address in respective input fields on the personal information input screen 4001, and presses the “Next” button 4011. The license information issuance server 101 encrypts the contents entered in respective input fields with the encryption key transmitted from the license information issuance server 101 and registers the encrypted personal information in a customer information database. The license information issuance server 101 cannot read the registered encrypted personal information because a decryption key is not present on the license information issuance server 101.

If the personal information server 180 restores its functions, the license information issuance server 101 transmits the stored encrypted personal information to the personal information server 180, which is indicated by the personal information server URL stored in the personal information server ID 5752 of the customer information table 5750. The personal information server 180 decrypts the encrypted personal information with the decryption key stored in the personal information server 180.

If in step S11407 the license information issuance server 101 determines that the license key can be issued, the processing proceeds to step S11409. In step S11409, the license information issuance server 101 generates an encrypted license key number (Lkey#) based on the entered device serial number and the option number being set and registers the generated Lkey# in the database. The license information issuance server 101 further generates the screen 11301 illustrated in FIG. 39 that displays the acquired license key number (Lkey#). The screen 11301 includes the button 11302 to be selected to generate a screen having an appropriate size for printing via the browser.

If in step S11403 it is determined that the issuance is already completed, the license information issuance server 101 performs the processing of step S11404. In step S11404, the license information issuance server 101 acquires the already encrypted license key number (Lkey#) from the database based on the entered device serial number and the option number being set. The license information issuance server 101 further generates the screen 11301 that displays the already acquired license key number (Lkey#).

The user can input the acquired license key to a device such as a printing apparatus. As a result, the option can be used on the printing apparatus. The device, when the license key is input, generates a license key number (Lkey#) based on its own device serial number and the option number being set. The device permits activation of the option based on a determination result as to whether the input license key number (Lkey#) is consistent with the license key number (Lkey#) generated by the device. Through the above-described procedure, the license information issuance server 101 can manage each manufactured and sold device and its option(s).

The above-described device may be different from the user terminal 102 or can be a system including the device integrated with the user terminal 102 if the system enables users to input the license key (Lkey#) under operation of a browser. In the above-described procedure, the processing order of the optional product registration and the device registration can be switched arbitrarily.

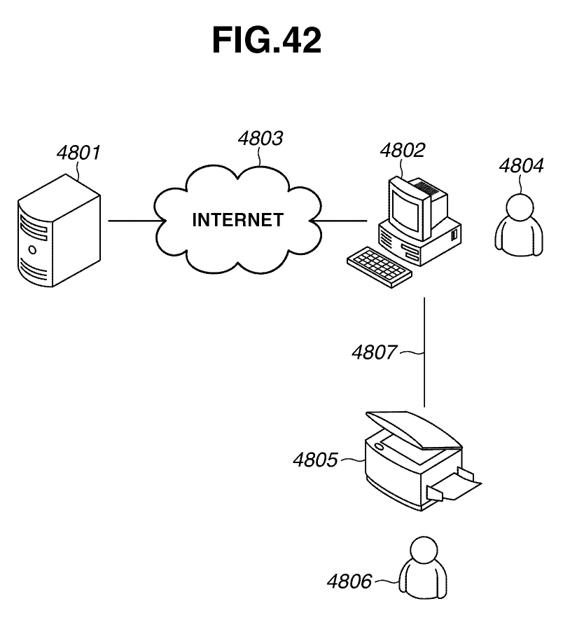

FIG. 42 illustrates an example of a system configuration of a network system according to a second exemplary embodiment of the present invention. A license information issuance server 4801 is an information processing apparatus (license file issuance apparatus) that manages license information issuance processing. A user terminal 4802 is an information processing apparatus that a user can manage. The user terminal 4802 is, for example, a personal computer, a portable terminal, a printer, or a copying machine. The user terminal 4802 may be an information processing apparatus that can install software via a network.

A network 4803 is, for example, the Internet. The user terminal 4802 can be connected to the license information issuance server 4801 via the network 4803. An operator 4804 operates the user terminal 4802. The operator 4804 operates the user terminal 4802 and can access the license information issuance server 4801 via the network 4803 to perform various license issuance operations. A multifunction peripheral (MFP) 4805, i.e., an example of the image processing apparatus, has various functions comparable to a printer, a scanner, a copying machine, and a facsimile. A plurality of applications and licenses can be installed on the MFP 4805. The MFP 4805 has a unique device ID. The MFP 4805 can copy the application and the license in the present embodiment.

A network 4807 is a network provided in the office. The user terminal 4802 and the MFP 4805 can be connected with each other via the network 4807. In the present embodiment, the user terminal 4802 and the MFP 4805 may not be connected to the same network 4807. A user 4806 operates the MFP 4805. The user 4806 can make the application or the license ineffective on the MFP 4805 and can acquire a license key verifying the ineffectiveness.

In the present embodiment, the operators 4804 and 4806 may be different persons or the same person. A functional configuration of the MFP 4805 is described below. An example hardware configuration of the MFP 4805, as illustrated in FIG. 2, includes a CPU and memories (ROM, RAM, etc.). The CPU executes programs stored in the memories to realize part or all of the following functions. The MFP 4805 has an operation panel functionally equivalent to the display apparatus 201 and the keyboard 204 illustrated in FIG. 2.

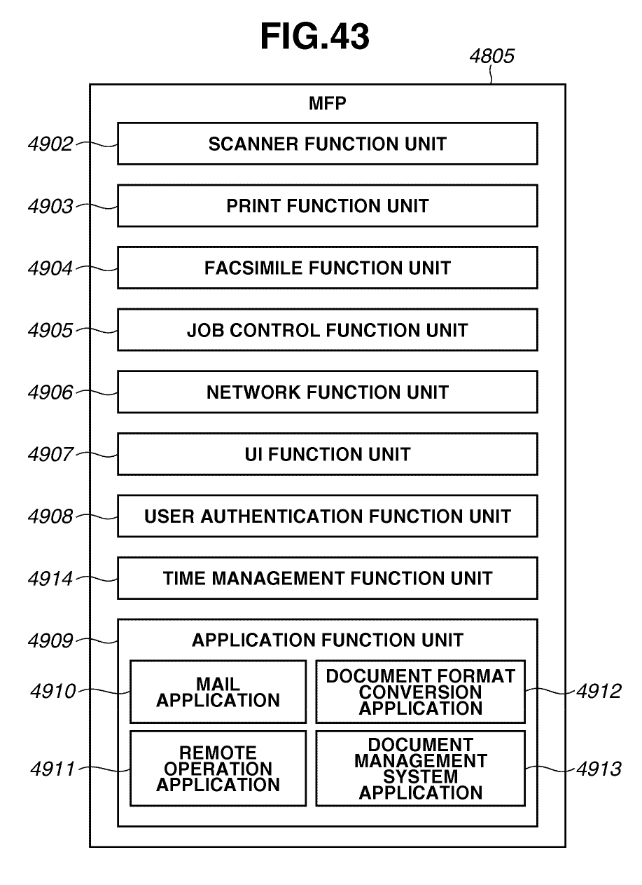

FIG. 43 illustrates an example of the functional configuration of the MFP 4805. A scanner function unit 4902 has a function of reading a paper document and converting the read data into binary image data. A print function unit 4903 has a function of outputting, to a printer device, the binary image data read and converted by the scanner function unit 4902 together with an added command corresponding to the printer device. A facsimile function unit 4904 performs encoding on the binary image data read and converted by the scanner function unit 4902 according to the facsimile standards (G3, G4, etc.). The facsimile function unit 4904 has a function of performing image communication with an external facsimile according to a protocol according to the facsimile standards. The facsimile function unit 4904 has a function of transmitting/receiving facsimile images to/from an external facsimile according to the facsimile standards.

A job control function unit 4905 performs job queuing on the binary image data received from the scanner function unit 4902 or the facsimile image data received from an external device by the facsimile function unit 4904. The job control function unit 4905 further has a job control function of adequately outputting the job to the print function unit 4903, the facsimile function unit 4904, and a network function unit 4906. The network function unit 4906 has various (e.g., TCP/IP, HTTP, FTP, LDAP, SNMP, SMTP, and SSL) network protocol functions. A user interface (UI) function unit 4907 manages user's input/output operation on the operation panel of the MFP 4805 and displays an input field and an output message field on the operation panel. The UI function unit 4907 receives an input value of the input field entered by the user and notifies the received value to other function units. The UI function unit 4907 further has a function of displaying a message for the user entered from another function unit on the screen designed beforehand.

A user authentication function unit 4908 has a function of authenticating the user. The user authentication function unit 4908 can use the UI function unit 4907 or an information terminal (not illustrated) operating on the network to respond to user authentication requests of various applications in an application function unit 4909. The user authentication function unit 4908 sets user authentication information for each application using a user authentication setting file. The user authentication function unit 4908 further has a function of authenticating the user who operates various functions of the MFP according to user authentication information stored in the MFP 4805 or in a user authentication server on the network.

The application function unit 4909 has a function of installing, performing user authentication, executing, and uninstalling various applications operating on the MFP 4805. The application function unit 4909 further sets an effective period of each application when the application is installed. The application function unit 4909 realizes an application having an effective period by determining the effective period having been set beforehand when the application is installed, using the function of a time management function unit 4914 when the application is executed. The application function unit 4909 can store effective period information in an application object, or may be set as another object (as additional information of the application) when the application is installed. The effective period can be indicated by the number of days starting from installation of the application.

The effective period is not limited to the number of days indicating an effective period of time as described in the present embodiment, and may be replaced with an expiration date (e.g., year, month, and day). If an expiration date is set, the application function unit 4909 can calculate the number of days indicating the effective period based on information obtained from a system clock provided in the MFP 4805. The number of days may be replaced with the number of hours, minutes, or seconds. As long as the built-in system clock can count a set time, the application function unit 4909 can calculate the effective period. The effective period is sent as an argument to an installation time setting function when the application is installed, and is stored in a nonvolatile storage area of the MFP 4805.

To start usage of an application on the MFP 4805, it is generally required to install the application and a license file that enables installation of the application. The application and the license file can be generally installed via the network, using the network function unit 4906, by a user of the MFP 4805 who operates a browser of a terminal (e.g., PC). If the application itself is already installed on the MFP 4805, the user can install only a license key for the application to make the functions provided by the application effective.

To start usage of an application on the MFP 4805, an enabling procedure (or processing) to be executed after installation of the application is required. A license key entered via the UI function unit 4907 is generally required to enable the application. The license key includes a function type and a device ID to be enabled. The network function unit 4906 can be used to obtain the license key via the network. The application can be enabled by inputting the license key to the MFP 4805. The MFP 4805 turns on a license bit that is present in the nonvolatile storage area of the MFP 4805, which corresponds to each application. Moreover, the MFP 4805 turns off the license bit to disable the application.

A Mail application 4910 is one of the applications provided by the MFP 4805, which operates on the application function unit 4909. The Mail application 4910 has a function of receiving an electronic mail including an attached electronic document, which is received from an information terminal via the network, using the network function unit 4906 and performing printing using the print function unit 4903. The Mail application 4910 further has a function of attaching an electronic document read by the scanner function unit 4902 to an electronic mail and transmitting the electronic mail including the attached electronic document to a pre-designated transfer destination.

A remote operation application 4911 is one of the applications provided by the MFP 4805, which operates on the application function unit 4909. The remote operation application 4911 has a function of displaying an interface on an information terminal (not illustrated) on the network, which is similar to the touch panel displayed on the MFP 4805, using the UI function unit 4907 and enabling a remote operation. A document format conversion application 4912 is one of the applications provided by the MFP 4805, which operates on the application function unit 4909. The document format conversion application 4912 has a function of converting the electronic data into an electronic data format that is set beforehand. Electronic data read by the operator using the scanner function unit 4902 and electronic data transmitted from an information terminal on the network can be conversion objects.

A document management system application 4913 is one of the applications provided by the MFP 4805, which operates on the application function unit 4909. The document management system application 4913 has a function of storing electronic data in a predetermined document storage place on the network or in the MFP 4805. Electronic data read by the operator using the scanner function unit 4902 and electronic data transmitted from an information terminal on the network can be storage objects. The Mail application 4910, the remote operation application 4911, the document format conversion application 4912, and the document management system application 4913 can perform user authentication. When the operator uses each application, the operator can use the user authentication function unit 4908 via the application function unit 4909.

The time management function unit 4914 has a built-in system clock and provides a built-in system clock interface, which enables time setting and reference, for all function modules in the MFP 4805. The time management function unit 4914 further has a function of counting a setting difference time since the system starts and storing a cumulative setting difference time in a nonvolatile storage area (e.g., flash ROM). The time management function unit 4914 further has a function of adjusting the time using a time synchronization service available on the network to which the MFP 4805 is connected. The time synchronization service is a service capable of synchronizing the time using a TIME protocol (RFC868), an NTP protocol (RFC1305), or an SNTP protocol (RFC1769). To determine the effective period of an application, the time management function unit 4914 has a function of setting the installation time when the application is installed.

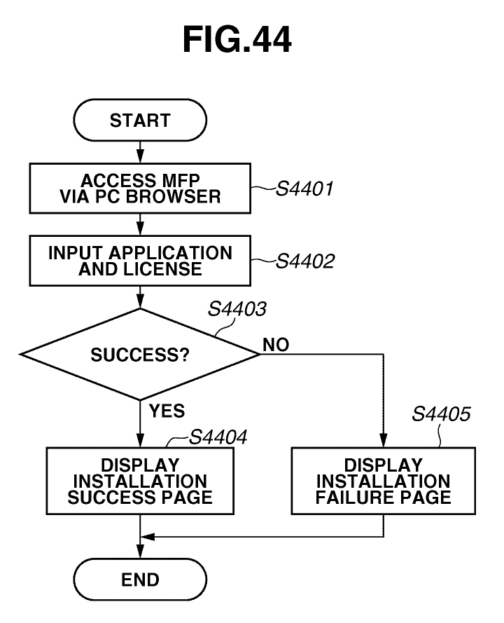

FIG. 44 is a flowchart illustrating the processing for installing an application and a license file including a resource to be used to customize the application on the MFP 4805. The user 4806 of the MFP 4805 acquires a license file from the license information issuance server 101. The license file in the present embodiment includes a resource (as described below) to be used to customize the application.

In step S4401, the user 4806 operates the user terminal 4802 and the browser software of the user terminal 4802 accesses the MFP 4805. The MFP 4805 returns a screen to be used to input an application and a license file. In step S4402, in response to an input by the user 4806, the browser software transmits the application and the license file to the MFP 4805. In step S4403, the MFP 4805 determines whether the installation of the application and the license file is successful. If the installation is successful, then in step S4404, the MFP 4805 returns an installation success page and the browser displays the installation success page. If the installation fails, then in step S4405, the MFP 4805 returns an installation failure page and the browser displays the installation failure page.

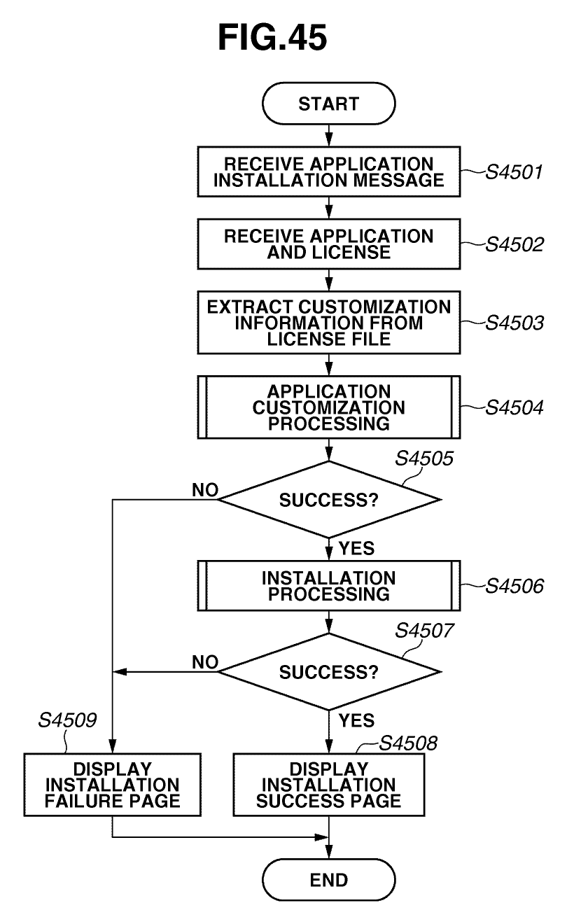

FIG. 45 is a flowchart illustrating an example of processing performed by the MFP 4805 to install the license illustrated in FIG. 44. In step S4501, the MFP 4805 receives a transmission message of the application and the license file from the user terminal 4802. In step S4502, the MFP 4805 receives the application and the license file. The license file includes a resource to be used to customize the application. In step S4503, the MFP 4805 extracts customization information (as described below) from the received license file.

In step S4504, the MFP 4805 performs application customization processing based on the extracted customization information. In step S4505, the MFP 4805 determines whether the application customization processing is successful. If the customization is successful, then in step S4506, the MFP 4805 performs installation of the application and the license file. If the installation is successful, then in step S4508, the MFP 4805 generates an installation success page and transmits the generated page to the user terminal 4802 and terminates the processing of the routine illustrated in FIG. 45. If the customization processing is failed, or if the installation is failed, then in step S4509, the MFP 4805 generates an installation failure page and transmits the generated page to the user terminal 4802. The MFP 4805 terminates the processing of the routine illustrated in FIG. 45.

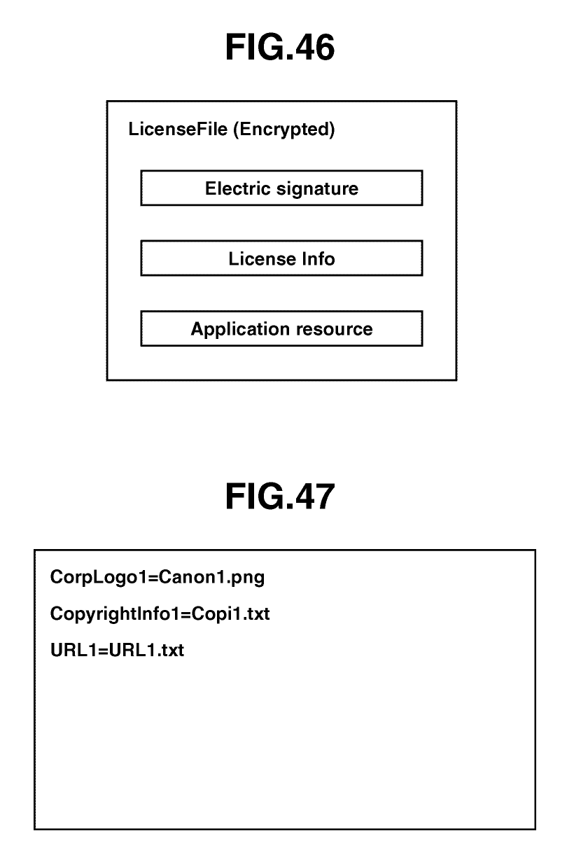

FIG. 46 illustrates a license file that includes application customization information. The license file is subjected to an electronic signature and includes electronic signature information. The license file further includes license information, which is required to decrypt the encrypted application. In the present embodiment, the license file includes application resource information (customization information) to be used to customize the application. The application resource information includes an image file, a copyright document (a text file), and a script to be activated when the application is installed or uninstalled, and also when the application is updated, started, or stopped.

FIG. 47 illustrates an example of the application resource information according to the present embodiment. The example illustrated in FIG. 47 designates an image file included in an application resource in a license file for logo information (CorpLogo1) which can be displayed on the UI function unit 4907 of the MFP 4805 illustrated in FIG. 43. The example illustrated in FIG. 47 further designates a text file included in the application resource in the license file for application copyright information (CopyrightInfo). The example illustrated in FIG. 47 designates a text file included in the application resource in the license file for URL (URL1) of link information included in the display of the application. When a license file issuance request is accepted, the license information issuance server 101 issues a license file that includes license information of an application of the MFP 4805 and customization information relating to customization of the application. The customization information includes meta information as described below.

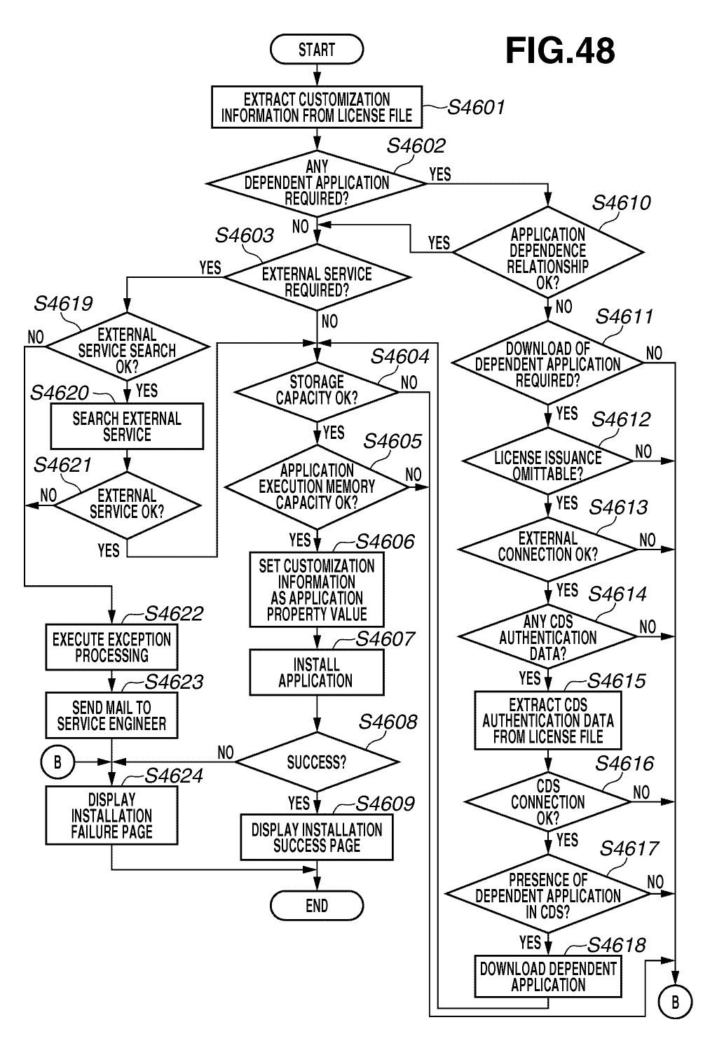

FIG. 48 is a flowchart illustrating an example of application customization processing performed by the MFP 4805, to install a license file including an application and application customization information. In step S4601, the MFP 4805 extracts customization information from a license file including application customization information. In step S4602, the MFP 4805 determines whether an application to be installed together with the license file requires another application (dependent application). For example, the MFP 4805 performs the determination based on meta information (e.g., dependence relationship information) described in the customization information. If the MFP 4805 determines that the dependent application is required, the processing proceeds to step S4610. If the MFP 4805 determines that the dependent application is not required, the processing proceeds to step S4603.

In step S4610, the MFP 4805 determines whether the application installed together with the license file and the existing (i.e., already installed on the MFP 4805) application satisfy a dependent relationship. For example, the MFP 4805 refers to the application installed together with the license file, the existing application, and the customization information to determine whether the dependent relationship is satisfied. If the MFP 4805 determines that the dependent relationship is satisfied, the processing proceeds to step S4603. If the MFP 4805 determines that the dependent relationship is not satisfied, the processing proceeds to step S4611.

In step S4611, the MFP 4805 determines whether downloading of the dependent application is necessary. The MFP 4805 refers to the meta information described in the customization information and determines the necessity of the download of the dependent application. If the MFP 4805 determines that the download of the dependent application is necessary, the processing proceeds to step S4612. If the MFP 4805 determines that the download of the dependent application is unnecessary, the processing proceeds to step S4624.

In step S4612, the MFP 4805 determines whether the issuance of the license file is omissible. For example, the MFP 4805 refers to the meta information described in the customization information and determines whether the issuance of the license file can be omitted. If the MFP 4805 determines that the issuance of the license file is omissible, the processing proceeds to step S4613. If the MFP 4805 determines that the issuance of the license file is not omissible, the processing proceeds to step S4624.

In step S4613, the MFP 4805 determines whether an external apparatus (or external service) relating to the dependent application is connectable. The MFP 4805 attempts to secure a connection to an external apparatus described in the customization information before determining whether the external apparatus is connectable. If the MFP 4805 determines that the external apparatus is connectable, the processing proceeds to step S4614. If the MFP 4805 determines that the external apparatus is not connectable, the processing proceeds to step S4624. In step S4614, the MFP 4805 determines whether the license file includes Contents Delivery Server (CDS) authentication data. If the MFP 4805 determines that the license file includes the CDS authentication data, the processing proceeds to step S4615. If the MFP 4805 determines that the license file does not include the CDS authentication data, the processing proceeds to step S4624.

In step S4615, the MFP 4805 extracts the CDS authentication data from the license file. In step S4616, the MFP 4805 determines whether the CDS is connectable based on the extracted CDS authentication data. If the MFP 4805 determines that the CDS is connectable, the processing proceeds to step S4617. If the MFP 4805 determines that the CDS is not connectable, the processing proceeds to step S4624. In step S4617, the MFP 4805 sends an inquiry about the presence of any dependent application to the CDS. If the MFP 4805 receives an inquiry result indicating that the dependent application is present in the CDS, the processing proceeds to step S4618. If the dependent application is not present in the CDS, the processing proceeds to step S4624.

In step S4618, the MFP 4805 downloads the dependent application from the CDS. In step S4624, the MFP 4805 generates an installation failure page and transmits the generated page to the user terminal 4802. The MFP 4805 terminates the processing of the routine illustrated in FIG. 48. In step S4603, the MFP 4805 determines whether the application installed together with the license file requires an external service. The MFP 4805 refers to the meta information described in the customization information and determines the necessity of the external service. If the MFP 4805 determines that the external service is necessary, the processing proceeds to step S4619. If the MFP 4805 determines that the external service is unnecessary, the processing proceeds to step S4604. The external service is, for example, a Lightweight Directory Access Protocol (LDAP) service available in the intranet.

The external service may include a database management Web service or an account management LDAP server. A print restricting application that manages a user account communicates with the LDAP server and performs download/setup of user account information. The MFP 4805 downloads the values restricting the number of printed sheets for each of a user A and a user B from the LDAP server and sets up the downloaded values. If the download from the LDAP server fails, the MFP 4805 stops the setup. If the download is successful, the MFP 4805 continues the setup.

A database that manages a corporate ID (logo), i.e., an example resource, is another example of the external service. The right to use and usage rules are set for the corporate logo. The MFP 4805 communicates with an external database upon installation and then downloads and displays the latest usage rules and cautions. If the download fails, the MFP 4805 stops installation and deletes the application.

A server that manages a security policy is another example of the external service. An example of the security policy is property information to be set up to the application when installed. A server that manages such a security policy may be described as an external service. The MFP 4805 communicates with a policy server (an example external service) when the application is installed, and downloads the security policy. The MFP 4805 sets up the property information to the application according to the security policy. If the setup fails, the MFP 4805 cancels the installation.

In step S4619, the MFP 4805 determines whether the external service can be searched using a protocol of the Web service. The MFP 4805 refers to the meta information described in the customization information (e.g., search information including a name of an external service (search object)) to determine whether the external service can be searched using the protocol of the Web service. If the MFP 4805 determines that the external service can be searched using the protocol of the Web service, the processing proceeds to step S4620. If the MFP 4805 determines that the external service cannot be searched using the protocol of the Web service, the processing proceeds to step S4622.

In step S4620, the MFP 4805 searches the external service using the protocol of the Web service. In step S4621, the MFP 4805 determines whether the retrieved external service is usable (connectable). The MFP 4805 refers to the meta information described in the customization information (e.g., connection information) and attempts to secure a connection to (or communicate with) the external service. Based on a result of the attempt, the MFP 4805 determines whether the external service is usable (connectable). If the MFP 4805 determines that the searched external service is usable, the processing proceeds to step S4604. If the MFP 4805 determines that the searched external service is unusable, the processing proceeds to step S4622.

In step S4622, the MFP 4805 executes exception processing. In step S4623, the MFP 4805 sends mail to a mail address of a service engineer, which is determined beforehand. The processing proceeds to step S4624. In step S4604, the MFP 4805 determines whether the storage device (e.g., ROM or HDD) has a sufficient capacity for storing the application. If the MFP 4805 determines that the storage capacity is sufficient for storing the application, the processing proceeds to step S4605. If the MFP 4805 determines that the storage capacity is insufficient, the processing proceeds to step S4624. If the dependent application is already downloaded in step S4618, the MFP 4805 determines whether the storage capacity is sufficient for the application to be installed.

In step S4605, the MFP 4805 determines whether the memory capacity (e.g., the capacity of RAM) is sufficient to execute the application to be installed. The MFP 4805 calculates a total memory amount used for all applications already installed in the MFP 4805 and subtracts the calculated memory amount from the available memory capacity. The MFP 4805 performs the determination based on a comparison between the calculated remaining memory capacity and an estimated memory amount to be used for the installation object application, which is included in the customization information. If the dependent application is already downloaded in step S4618, the MFP 4805 compares the calculated remaining memory capacity with an estimated memory amount to be used for the installation object application and the dependent application, to perform the determination. The estimated memory amount to be used for the dependent application can be determined beforehand, or may be the same as the estimated memory amount to be used for the installation object application.

In step S4606, the MFP 4805 sets the customization information as property values of the application. In step S4607, the MFP 4805 installs the application. If the dependent application is already downloaded in step S4618, the MFP 4805 installs both the object application and the dependent application. If the processing proceeds to step S4604 after the MFP 4805 determines that the searched external service is usable in step S4621, the MFP 4805 installs the application using the external service. If the processing proceeds to step S4604 after the MFP 4805 determines that the searched external service is usable in step S4621, the MFP 4805 may set information as the property value of the application using the external service before installing the application.

In step S4608, the MFP 4805 determines whether the installation of the application is successful. If the MFP 4805 determines that the installation of the application is successful, the processing proceeds to step S4609. If the MFP 4805 determines that the installation of the application is failed, the processing proceeds to step S4624. In step S4609, the MFP 4805 generates an installation success page and transmits the generated page to the user terminal 4802. Then, the MFP 4805 terminates the processing of the routine illustrated in FIG. 48.

The present invention can be realized using a storage medium (or a recording medium) that stores a software program code for realizing the functions of the above-described embodiments and that can be supplied to a system or an apparatus. A central processing unit (CPU or micro-processing unit (MPU)) in the system or the apparatus can read and execute the program code. In this case, the program code itself read out of the storage medium can realize the functions of the above-described embodiments. The storage medium storing the program code constitutes the present invention.

When the central processing unit of the system or the apparatus executes the program code, an operating system (OS) or other application software running on the system or the apparatus can execute part or all of the actual processing based on instructions of the program code. Through the above-described processing, the functions of the above-described embodiment can be realized.

Additionally, the program code read out of a storage medium may be written into a memory of a function expansion card inserted in a system or an apparatus or into a memory of a connected function expansion unit. Based on instructions of the program code, a CPU provided on the function expansion card or the function expansion unit can execute part or all of actual processing to realize the functions of the above-described embodiments.

When the present invention is applied to a storage medium, a program code corresponding to the above-described flowcharts is stored in the storage medium (i.e., a computer-readable storage medium).

As described above, the license file includes application customization information. Therefore, customization of an application can be performed simultaneously with installation of the license file. The present embodiments can reduce an application setting work that was conventionally required after installation of the application. Any setting errors during the installation can be prevented because application settings and resources can be designated when the license is issued. It is unnecessary to create a specific application dedicated to a specific customer (client), such as the one including a corporate logo changed for each client, as an application customizable by a license file can be prepared.

The customizable application, if a resource can be added from an external terminal, may be falsified by an external access. However, according to the above-described embodiments, the license file requires an electronic signature and cannot be installed without signature verification. Therefore, the present embodiments can prevent the customizable application from being falsified.

In addition to customization of resources, property value ON/OFF information of an application can be added to a license file. Restriction against any access to unnecessary property can be included when the license is issued. The MFP 4805 can determine the installability by checking the presence of a server, a service, or an installed application, which is necessary for the customizable application, based on Meta information relating to installation included in the license file.

The MFP 4805 can download an additional application from an external apparatus (e.g., application delivery server) and install the downloaded application referring to the Meta information relating to installation included in the license file. As the application delivery server (or connection information of the application delivery server) is described in the license file, the MFP 4805 can install the additional application while preventing a wrong application from being downloaded from an inappropriate web site. As the MFP 4805 is already in a license authenticated state (namely, as the MFP 4805 is operating based on information described in the license file), the MFP 4805 can omit sequential processes (license issuance, authentication, etc.) when the additional application is installed. The MFP 4805 can also omit license issuance for the additional application. Therefore, the present embodiments can improve the usability of users and can reduce the work of service engineers.

While the present invention has been described with reference to various embodiments, it is to be understood that the invention is not limited to the disclosed embodiments. The scope of the following claims is to be accorded the broadest interpretation so as to encompass all modifications, equivalent structures, and functions.

This application claims priority from Japanese Patent Application No. 2008-074392 filed Mar. 21, 2008, which is hereby incorporated by reference herein in its entirety.

What is claimed is:

1. An apparatus for issuing license files comprising:
an acceptance unit configured to accept a license file issuance request; and
a license file issuance unit configured to issue a license file that includes license information for a first application of an image processing apparatus and customization information relating to customization of the first application if the acceptance unit accepts the license file issuance request.

2. The apparatus according to claim 1, wherein the license file issuance unit is configured to issue a license file including, as the customization information, application information of a second application in a dependent relationship with the first application.

3. The license file issuance apparatus according to claim 2, wherein the license file issuance unit is configured to issue a license file including, as the customization information, connection information relating to a delivery apparatus that delivers the second application in addition to the first application information.

4. The license file issuance apparatus according to claim 1, wherein the license file issuance unit is configured to issue a license file including, as the customization information, information indicating whether to require a service provided by an external service with respect to installation of the first application in the image processing apparatus.

5. The license file issuance apparatus according to claim 1, wherein the license file issuance unit is configured to issue a license file including, as the customization information, search information relating to a search of an external service in addition to information indicating whether to require a service provided by the external service with respect to installation of the first application in the image processing apparatus.

6. An image processing apparatus comprising:
a reception unit configured to receive a license file that includes license information for a first application and customization information relating to customization of the first application;
an extraction unit configured to extract the license information and the customization information from the license file received by the reception unit; and
an installation unit configured to install the first application based on the license information and the customization information extracted by the extraction unit.

7. The image processing apparatus according to claim 6, wherein the installation unit is configured to determine whether a download of a second application is required based on application information of the second application in a dependent relationship with the first application included in the customization information and, if the download is not required, is configured to install the first application.

8. The image processing apparatus according to claim 6, wherein the installation unit is configured to determine whether a download of a second application is required based on application information of the second application in a dependent relationship with the first application included in the customization information and, if the download is required, is configured to access a delivery apparatus that delivers the second application based on connection information included in the customization information and install the first application after completing the download of the second application.

9. The image processing apparatus according to claim 6, wherein the installation unit is configured to determine whether a service provided by an external service is required with respect to installation of the first application, based on information included in the customization information that indicates whether to require the service provided by the external service and, if the service provided by the external service is not required, is configured to install the first application.

10. The image processing apparatus according to claim 6, wherein the installation unit is configured to determine whether a service provided by an external service is required with respect to installation of the first application, based on information included in the customization information that indicates whether to require the service provided by the external service and, if the service provided by the external service is required, is configured to search the external service based on search information relating to a search of the external service included in the customization information and install the first application using the service provided by the external service.

11. A method for issuing a license file in a license file issuance apparatus, the method comprising:
accepting a license file issuance request; and
issuing a license file that, if the license file issuance request is accepted, includes license information for a first application of an image processing apparatus and customization information relating to customization of the first application.

12. The method according to claim 11, further comprising issuing a license file including, as the customization information, application information of a second application in a dependent relationship with the first application.

13. The method according to claim 12, further comprising issuing a license file including, as the customization information, connection information relating to a delivery apparatus that delivers the second application in addition to the first application information.

14. The method according to claim 11, further comprising issuing a license file including, as the customization information, information indicating whether to require a service provided by an external service with respect to installation of the first application in the image processing apparatus.

15. The method according to claim 11, further comprising issuing a license file including, as the customization information, search information relating to a search of an external service in addition to information indicating whether to require a service provided by the external service with respect to installation of the first application in the image processing apparatus.

16. A method comprising:
receiving a license file that includes license information for a first application of an image processing apparatus and customization information relating to customization of the first application;
extracting the license information and the customization information from the received license file; and
installing the first application based on the extracted license information and the customization information.

17. The method according to claim 16, further comprising: determining whether a download of a second application is required based on application information of the second application in a dependent relationship with the first application included in the customization information and, if the download is not required, installing the first application.

18. The method according to claim 16, further comprising determining whether a download of a second application is required based on application information of the second application in a dependent relationship with the first application included in the customization information and, if the download is required, accessing a delivery apparatus that delivers the second application based on connection information included in the customization information and installing the first application after completing the download of the second application.

19. The method according to claim 16, further comprising determining whether a service provided by an external service is required with respect to installation of the first application in the image processing apparatus, based on information included in the customization information that indicates whether to require the service provided by the external service and, if the service provided by the external service is not required, installing the first application.

20. The method according to claim 16, further comprising
determining whether a service provided by an external service is required with respect to installation of the first application in the image processing apparatus, based on information included in the customization information that indicates whether to require the service provided by the external service and, if the service provided by the external service is required, searching the external service based on search information relating to a search of the external service included in the customization information and installing the first application using the service provided by the external service.

21. A computer-readable storage medium storing a control program that causes an apparatus to issue a license file, the program comprising:
accepting a license file issuance request; and
issuing a license file that, if the license file issuance request is accepted, includes license information for an application of an image processing apparatus and customization information relating to customization of the application.

22. A computer-readable storage medium storing a control program that causes an image processing apparatus to install an application, the program comprising:
receiving a license file that includes license information for an application of an image processing apparatus and customization information relating to customization of the application;
extracting the license information and the customization information from the received license file; and
installing the application based on the extracted license information and the customization information.
